(19) United States
(12) Patent Application Publication
(10) Pub. No.: US 2025/0299650 A1
(43) Pub. Date: Sep. 25, 2025

(54) MUSICAL INSTRUMENT AND PRODUCING METHOD THEREOF

(71) Applicant: YAMAHA CORPORATION, Hamamatsu-shi (JP)

(72) Inventors: Yoshiyuki HIRAI, Hamamatsu-shi (JP); Ichiro OSUGA, Hamamatsu-shi (JP); Kazuki SOGA, Hamamatsu-shi (JP); Yuji TAKAHASHI, Hamamatsu-shi (JP); Yoshihiro KATSUMATA, Hamamatsu-shi (JP); Kazuki KASHIWASE, Tokyo (JP)

(21) Appl. No.: 19/230,810

(22) Filed: Jun. 6, 2025

Related U.S. Application Data
(63) Continuation of application No. PCT/JP2023/045383, filed on Dec. 18, 2023.

(30) Foreign Application Priority Data
Dec. 19, 2022 (JP) 2022-202497

(51) Int. Cl. G10C 3/02; G10C 9/00; G10H 1/00; G10H 1/32

(52) U.S. Cl. CPC G10C 3/02; G10C 9/00; G10H 1/0008; G10H 1/32; G10H 2220/066

(57) ABSTRACT

A musical instrument includes an exterior member comprising an isotropic fiberboard. The isotropic fiberboard includes a base surface that has a first region and a second region. A surface roughness of the first region differs from a surface roughness of the second region; and a degree of reflection of the first region differs from a degree of reflection of the second region.

### CROSS REFERENCE TO RELATED APPLICATIONS

This application is a Continuation application of PCT Application No. PCT/JP2023/045383, filed on Dec. 18, 2023, and is based on, and claims priority from Japanese Patent Application No. 2022-202497, filed on Dec. 19, 2022, the entire contents of each of which are incorporated herein by reference.

### BACKGROUND OF THE INVENTION

### Field of the Invention

This disclosure relates to musical instruments.

### Description of the Related Art

Techniques have been proposed for material construction of an exterior of a musical instrument such as a keyboard musical instrument. For example, Examined Japanese Patent Publication No. Shou 55-5117 discloses a technique for material construction of a left side and a right side of a keyboard musical instrument, each of which is constructed of a wood core coated with a synthetic resin. However, the technique disclosed in Examined Japanese Patent Publication No. Shou 55-5117 gives rise to a disadvantage in that an exterior of such a keyboard musical instrument tends to lack a high-grade texture and to be monotonous in design.

### SUMMARY OF THE INVENTION

In view of the circumstances described above, an object of one aspect of this disclosure is to realize a variety of designs with variations in appearance of an exterior of a musical instrument.

In one aspect of this disclosure, a musical instrument includes an exterior member comprising an isotropic fiberboard, wherein the isotropic fiberboard includes an exterior surface comprising a first region and a second region, wherein a surface roughness of the first region differs from a surface roughness of the second region, and wherein a degree of reflection of the first region differs from a degree of reflection of the second region.

In another aspect, a musical instrument includes an exterior member comprising an isotropic fiberboard, and a light emitter, wherein the isotropic fiberboard includes an exterior surface and has a rear surface that faces away from the exterior surface, wherein the rear surface includes a recess, wherein the light emitter is disposed within the recess, and wherein the light emitter is configured to emit light that passes through the exterior surface of the isotropic fiberboard.

In yet another aspect, a method for producing a musical instrument is a method that comprises roughening, by irradiation with a laser, a first region of an exterior surface of an isotropic fiberboard, and applying a paint to the exterior surface, wherein the isotropic fiberboard having the roughened and painted exterior surface is an exterior member of the musical instrument.

In yet another aspect, a musical instrument includes a first exterior member including a wood-based material, wherein the first exterior member includes a base surface constituting an exterior of the first exterior member, and a plurality of decorative portions that are recessed in or protrude from the base surface, wherein a degree of lightness of a side wall surface of each of the plurality of decorative portions is less than a degree of lightness of the base surface, and wherein in a plan view of the base surface, each of the plurality of decorative portions is elongated along a first direction of the base surface.

In yet another aspect, a musical instrument includes a first exterior member, wherein the first exterior member includes a plate-shaped member including a base surface provided with an opening, and a design member fitted to the opening of the plate-shaped member, wherein the design member includes a design surface having a normal line along a normal line of the base surface, wherein a degree of lightness of the design surface is less than a degree of lightness of the base surface, and wherein the design surface is provided with a plurality of protrusions arranged between a pair of opposite sides of the design member.

In yet another aspect, a musical instrument includes a first exterior member comprising an isotropic fiberboard, wherein the isotropic fiberboard includes a base surface constituting an exterior of the musical instrument, wherein the base surface includes a plurality of decorative portions, and a surrounding region other than the plurality of decorative portions, wherein a degree of lightness of the plurality of decorative portions differs from a degree of lightness of the surrounding region, and wherein in a plan view of the base surface, each of the plurality of decorative portions is elongated along a first direction of the base surface.

### BRIEF DESCRIPTION OF THE DRAWINGS

FIG. 1 is a perspective view of a keyboard musical instrument according to a first embodiment.

FIG. 2 is a block diagram showing an internal configuration of the keyboard musical instrument.

FIG. 3 is a perspective view of an exterior member according to the first embodiment.

FIG. 4 is a cross-sectional view taken along line IV-IV shown in FIG. 3.

FIG. 5 is a perspective view of an exterior member according to a second embodiment.

FIG. 6 is a cross-sectional view taken along line VI-VI shown in FIG. 5.

FIG. 7 is a perspective view of an exterior member according to a third embodiment.

FIG. 8 is a cross-sectional view taken along line VIII-VIII shown in FIG. 7.

FIG. 9 is an exploded perspective view of the exterior member according to the third embodiment.

FIG. 10 is a perspective view of an exterior member according to a fourth embodiment.

FIG. 11 is a plan view of an exterior member according to a fifth embodiment.

FIG. 12 is a cross-sectional view taken along line XII-XII shown in FIG. 11.

FIG. 13 is a flowchart showing a process for production of the exterior member according to the fifth embodiment.

FIG. 14 is a cross-sectional view of a molded body produced by a molding process.

FIG. 15 is a plan view of an exterior member according to a sixth embodiment.

FIG. 16 is a plan view of an exterior member according to a seventh embodiment.

FIG. 17 is a perspective view of an exterior member according to an eighth embodiment.

FIG. 18 is a cross-sectional view taken along line XVIII-XVIII shown in FIG. 17.

FIG. 19 is a flowchart showing a process for production of the exterior member according to the eighth embodiment.

FIG. 20 is an explanatory diagram showing a roughening process.

FIG. 21 is a flowchart of a production process according to a modification of the eighth embodiment.

FIG. 22 is a perspective view of an exterior member according to the modification of the eighth embodiment.

FIG. 23 is a plan view of an exterior member according to a ninth embodiment.

FIG. 24 is a cross-sectional view taken along line XXVI-XXVI shown in FIG. 23.

FIG. 25 is a cross-sectional view of an exterior member according to a modification of the ninth embodiment.

FIG. 26 is a cross-sectional view of an exterior member according to a modification of the first embodiment.

FIG. 27 is a cross-sectional view of an exterior member according to another modification of the first embodiment.

FIG. 28 is a cross-sectional view of an exterior member according to a modification of the second embodiment.

FIG. 29 is a cross-sectional view of an exterior member according to another modification of the second embodiment.

FIG. 30 is a perspective view of an exterior member according to a modification of the fourth embodiment.

FIG. 31 is a plan view of a part of an exterior member according to a modification.

### DESCRIPTION OF THE EMBODIMENTS

### A: First Embodiment

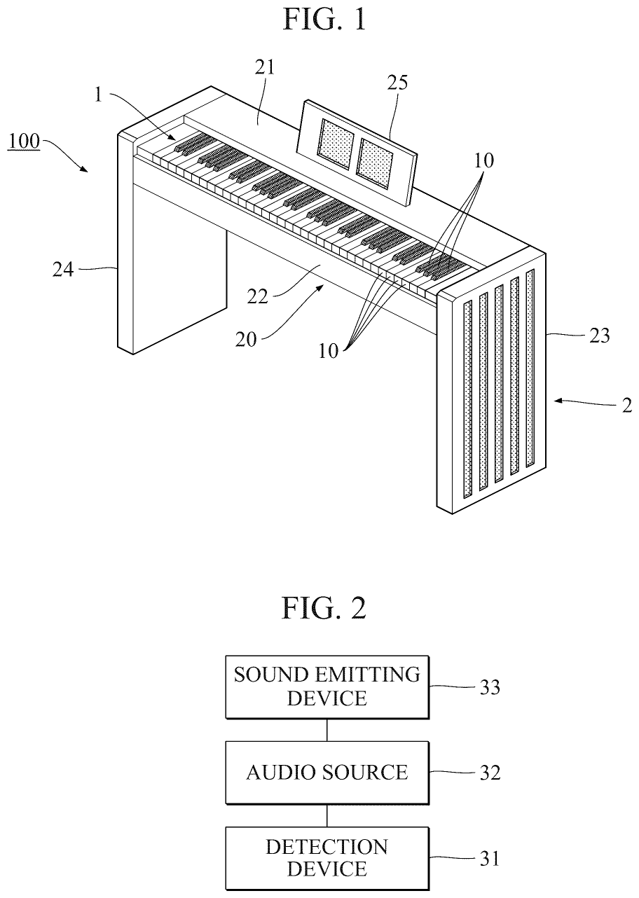

FIG. 1 is a perspective view of a keyboard musical instrument 100 according to a first embodiment. The keyboard musical instrument 100 is an electronic musical instrument that is configured to produce musical sounds in accordance with playing of a piece of music by a player of the keyboard musical instrument 100. The keyboard musical instrument 100 according to the first embodiment is an electronic piano that includes a keyboard 1 and a support 2.

The keyboard 1 has a plurality of keys 10 each of which corresponds to a different musical pitch. The plurality of keys 10 includes white keys and black keys. Each of the plurality of keys 10 is operable by the player of the keyboard musical instrument 100 by being depressed or released. To produce a sequence of musical sounds, the player plays a sequence of keys 10 corresponding to desired musical pitches. The plurality of keys 10 are aligned from left to right in order of ascending pitch.

FIG. 2 is a block diagram showing an internal configuration of the keyboard musical instrument 100. As shown in FIG. 2, the keyboard musical instrument 100 includes a detection device 31, an audio source 32, and a sound emitting device 33. The detection device 31, the audio source 32, and the sound emitting device 33 are accommodated in a housing 20.

The detection device 31 is a sensor that is configured to sense a key-touch operation of any one of the plurality of keys 10 played by the player. Specifically, the detection device 31 detects a key-touch operation of any one of the plurality of keys 10, which may be depression of one of the plurality of keys 10 or release of one of the plurality of keys 10. For example, the detection device 31 is a sensor that is configured to sense optically, mechanically, or magnetically displacement of any one of the plurality of keys 10.

The audio source 32 generates an audio signal in accordance with playing by the player of the keyboard musical instrument 100. The audio signal is a signal representative of a musical sound with a pitch corresponding to a key 10 played by the player. The audio source 32 may be a software audio source implemented by a general-purpose processor, or alternatively, the audio source 32 may be a hardware audio source implemented by a dedicated electronic circuit.

The sound emitting device 33 emits the musical sound represented by the audio signal. For example, the sound emitting device 33 may be constituted of a single loudspeaker, or alternatively, the sound emitting device 33 may be constituted of two or more loudspeakers. It is of note that the sound emitting device 33 may be constituted of headphones that are worn on the head of the player.

In FIG. 1, the support 2 is a structure that accommodates and supports the keyboard 1. The support 2 according to the first embodiment includes the housing 20, a right leg 23, a left leg 24, and a music stand 25. The housing 20 is a hollow structure that accommodates and supports the keyboard 1. The housing 20 according to the first embodiment includes an upper member 21 and a lower member 22. The upper member 21 is a member that constitutes an upper surface of the housing 20. The lower member 22 is a member that constitutes a bottom surface of the housing 20.

The right leg 23 and the left leg 24 are flat plate-shaped structures that support each of the housing 20 and the keyboard 1 at a predetermined height. The housing 20 is disposed between the right leg 23 and the left leg 24. The keyboard 1 is accommodated in the housing 20. The music stand 25 is disposed on the upper member 21 to support a musical score.

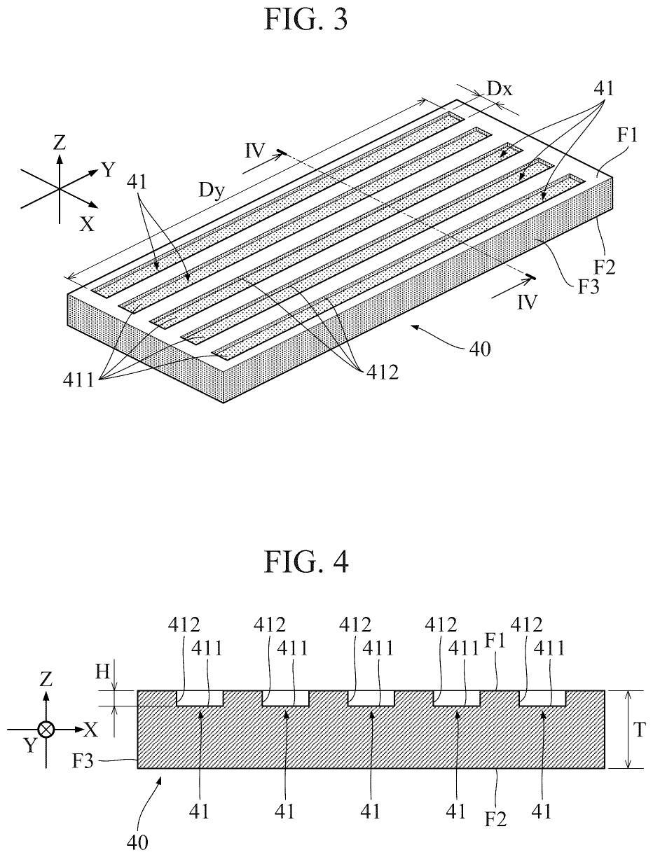

FIG. 3 is a perspective view of an exterior member 40 included in the keyboard musical instrument 100. FIG. 4 is a cross-sectional view taken along line IV-IV shown in FIG. 3. The exterior member 40 is a plate-shaped member. The right leg 23 and the left leg 24 are each constituted of the exterior member 40. In other words, the keyboard musical instrument 100 includes the exterior member 40. In the following description, an X-axis, a Y-axis, and a Z-axis each perpendicular to one another are assumed.

The plate-shaped exterior member 40 is elongated and extends longitudinally in a direction of the Y-axis. The exterior member 40 has a main surface (hereinafter referred to as a “base surface F1”), a rear surface that faces away from the base surface F1 (hereinafter referred to as a “rear surface F2”), and a side surface F3 that connects the base surface F1 and the rear surface F2 to each other. Each of the base surface F1 and the rear surface F2 is a plane surface parallel to an X-Y plane.

The base surface F1 is an exterior surface that constitutes an exterior of the exterior member 40. For example, the exterior member 40 that constitutes the right leg 23 is fitted to the housing 20 such that a normal line of a base surface F1 of the exterior member 40 faces away from the left leg 24. On the other hand, the exterior member 40 that constitutes the left leg 24 is fitted to the housing 20 such that a normal line of a base surface F1 of the exterior member 40 faces away from the right leg 23. In FIG. 3 and in FIG. 4, a direction of the Z-axis corresponds to a direction of thickness of the exterior member 40. In FIG. 4, T denotes a thickness of the exterior member 40. The thickness T constitutes a distance between the base surface F1 of the exterior member 40 and the rear surface F2 of the exterior member 40.

The exterior member 40 according to the first embodiment is in a form of an isotropic fiberboard made by subjecting fibers of a wood-based material to heat and pressure, and molding the fibers together into a desired shape. The exterior member 40 is an example of an isotropic fiberboard. The exterior member 40 is constituted of a fiberboard such as medium density fiberboard (MDF), hardboard, or insulation board. As described above, the exterior member 40 includes the wood-based material.

The wood-based material is a material constituted of small pieces of wood, and may be constituted of small pieces of wood only, such as a wood flour, or may be constituted of small pieces of wood combined with a resin material (for example, a synthetic resin). The wood-based material is constituted of small pieces of wood of a tree species such as spruce, Ezo spruce, Agathis, maple, kava, Mansonia altissima, sapele, Australian blackwood, ebony, rosewood, Honduran rosewood, African padauk, granadilla, Pao rosa, walnut, sono keling, ash, ovangkol, olive, or eucalyptus.

The base surface F1 of the exterior member 40 is provided with a plurality of decorative portions 41. The plurality of decorative portions 41 each constitute a recess in the base surface F1, and includes a step surface 411 and a side wall surface 412. The step surface 411 of each of the plurality of decorative portions 41 is a bottom surface that is parallel to the X-Y plane at a level lower than a level of the base surface F1. The side wall surface 412 of each of the plurality of decorative portions 41 is an inner wall surface of the recess and is parallel to the Z-axis. The side wall surface 412 connects the base surface F1 and the step surface 411 to each other. In other words, the plurality of decorative portions 41 according to the first embodiment are each a bottomed hole provided in the base surface F1.

A size H of a difference in level between the step surface 411 and the base surface F1 is greater than or equal to 1% of the thickness T of the exterior member 40 (H≥0.01 T). Specifically, the size H of the difference in level between the step surface 411 and the base surface F1 is greater than or equal to 5% of the thickness T of the exterior member 40 (H≥0.05 T), and is preferably greater than or equal to 10% of the thickness T of the exterior member 40 (H≥0.1 T). It is of note that the size H of the difference in level between the step surface 411 and the base surface F1 is a depth of each of the recesses that constitute the plurality of decorative portions 41 (a difference in height between the base surface F1 and the step surface 411).

As viewed in a direction along the Z-axis (hereinafter referred to as “in plan view”), the plurality of decorative portions 41 are each elongated in the direction of the Y-axis of the base surface F1. FIG. 3 shows a size Dx of each of an outer shape of the plurality of decorative portions 41 in a direction of the X-axis, and a size Dy of the outer shape of each of the plurality of decorative portions 41 in the direction of the Y-axis. An aspect ratio Dy/Dx is greater than or equal to 2, the aspect ratio being a ratio of the size Dy to the size Dx. Specifically, a planer shape of each of the plurality of decorative portions 41 is linearly elongated in the direction of the Y-axis, for example. As described above, longitudinal directions of the plurality of decorative portions 41 are parallel to one another. In other words, the longitudinal directions of the plurality of decorative portions 41 are uniform. It is of note that the direction of the Y-axis is an example of a “first direction,” and the direction of the X-axis is an example of a “second direction.”

The plurality of decorative portions 41 described above are each formed by removing a portion of the base surface F1 of the plate-shaped exterior member 40. For example, the plurality of decorative portions 41 are portions that are cut into the base surface F1 by using, for example, a cutter such as a rotary blade. A surface roughness of the side wall surface 412 of each of the plurality of decorative portions 41 is greater than a surface roughness of the step surface 411 of each of the plurality of decorative portions 41. In other words, the side wall surface 412 of each of the plurality of decorative portions 41 is rougher than the step surface 411 of each of the plurality of decorative portions 41. In addition, the surface roughness of the step surface 411 of each of the plurality of decorative portions 41 is greater than a surface roughness of the base surface F1. In other words, the step surface 411 of each of the plurality of decorative portions 41 is rougher than the base surface F1. Thus, the surface roughness of the side wall surface 412 of each of the plurality of decorative portions 41 is greater than the surface roughness of the base surface F1. In other words, the side wall surface 412 of each of the plurality of decorative portions 41 is rougher than the base surface F1.

The fiberboard constituting the exterior member 40 is produced by pressing together fibers of the wood-based material in the direction of the Z-axis. In other words, the base surface F1 and the rear surface F2 are formed under pressure applied by a flat jig. As a result, a surface roughness of each of the base surface F1 and the rear surface F2 is less than a surface roughness of the side surface F3. In other words, the side surface F3 of the exterior member 40 is rougher than the base surface F1 and the rear surface F2.

Paint is applied to an outer surface of the exterior member 40. The paint applied to the exterior member 40 is, for example, a permeating resin material such as a wax or an oil. The paint includes a colorant such as a black pigment or a black dye. The paint is applied to each surface of the exterior member 40. Specifically, the paint is applied not only to the base surface F1, the rear surface F2, and the side surface F3 of the exterior member 40, but also to the step surface 411 and the side wall surface 412 of each of the plurality of decorative portions 41.

The rougher a surface is the more permeable the surface tends to be. As noted, the paint includes a colorant. Thus, a greater an amount of paint that permeates the surface, a less a degree of lightness is of the painted surface. The degree of lightness is defined as a Munsell value V within a range of 0 (black) or more and 10 (white) or less, for example. Inherent to a degree of lightness of a Munsell value V is a degree of (reflective) luminance.

As described above, the surface roughness of the side wall surface 412 of each of the plurality of decorative portions 41 is greater than the surface roughness of the step surface 411; thus, a degree of lightness of the side wall surface 412 is less than a degree of lightness of the step surface 411. In other words, a color tone of the side wall surface 412 is closer to black than a color tone of the step surface 411. In addition, the surface roughness of the step surface 411 of each of the plurality of decorative portions 41 is greater than the surface roughness of the base surface F1; thus, the degree of lightness of the step surface 411 is less than a degree of lightness of the base surface F1. In other words, the color tone of the step surface 411 is closer to black than a color tone of the base surface F1. Thus, the degree of lightness of the side wall surface 412 of each of the plurality of decorative portions 41 is less than the degree of lightness of the base surface F1. In other words, the color tone of the side wall surface 412 is closer to black than the color tone of the base surface F1.

As described above, the exterior member 40 is in a form of the isotropic fiberboard. Thus, for example, in a configuration (hereinafter referred to as a “comparative example”) in which no decorative portion 41 is provided, an exterior of the exterior member 40 is monotonous in texture and lacks variation in design. In contrast to the comparative example, in the first embodiment, a uniform appearance is achieved by a configuration in which the longitudinal directions of the plurality of decorative portions 41 are uniform; also, design variations are made possible by a configuration in which a degree of lightness of the side wall surface 412 of each of the plurality of decorative portions 41 differs from a degree of lightness of the base surface F1. Accordingly, it is possible to realize, for example, an antique design that imparts a sense of luxury.

In the configuration according to the first embodiment a sufficient side wall surface 412 of each of the plurality pf decorative portions 41 is secured (H≥0.01 T). Thus, it is possible to realize a variety of designs in which a difference in a degree of lightness between the side wall surface 412 of each of the plurality of decorative portions 41 and the base surface F1 is emphasized. Furthermore, in the first embodiment, the base surface F1 is provided with the plurality of decorative portions 41, each of which has the aspect ratio Dy/Dx of 2 or more, such that a longitudinal direction of each of the plurality of decorative portions 41 is along the Y-axis. Thus, it is possible to emphasize uniformity of appearance of the exterior member 40.

As described above, the surface roughness of the side surface F3 of the exterior member 40 is greater than a surface roughness of a region of the base surface F1 other than the plurality of decorative portions 41. Thus, a degree of average lightness of the side surface F3 of the exterior member 40 is less than a degree of average lightness of the region of the base surface F1 other than the plurality of decorative portions 41. In other words, a color tone of the side surface F3 of the exterior member 40 is closer to black than the color tone of the base surface F1. According to the above-described embodiment, compared to a configuration in which the degree of average lightness of the side surface F3 of the exterior member 40 is substantially the same as the degree of average lightness of the base surface F1 of the exterior member 40, it is possible to realize a variety of designs with rich variations in appearance.

Furthermore, in the first embodiment, the plurality of decorative portions 41 are each provided along the longitudinal direction of the exterior member 40. Thus, it is possible to realize a visual effect such that the plurality of decorative portions 41 has an appearance of a wood grain in a longitudinal direction of a wooden plate. This visual effect imparts an impression that a strength of the exterior member 40 in its longitudinal direction is greater than a strength of the exterior member 40 in its lateral direction.

### B: Second Embodiment

A second embodiment will now be described. In the descriptions in each of the following embodiments, elements that have the same functions as those in the first embodiment are denoted by the same reference numerals used to denote like elements in the description of the first embodiment, and detailed description thereof is omitted, as appropriate.

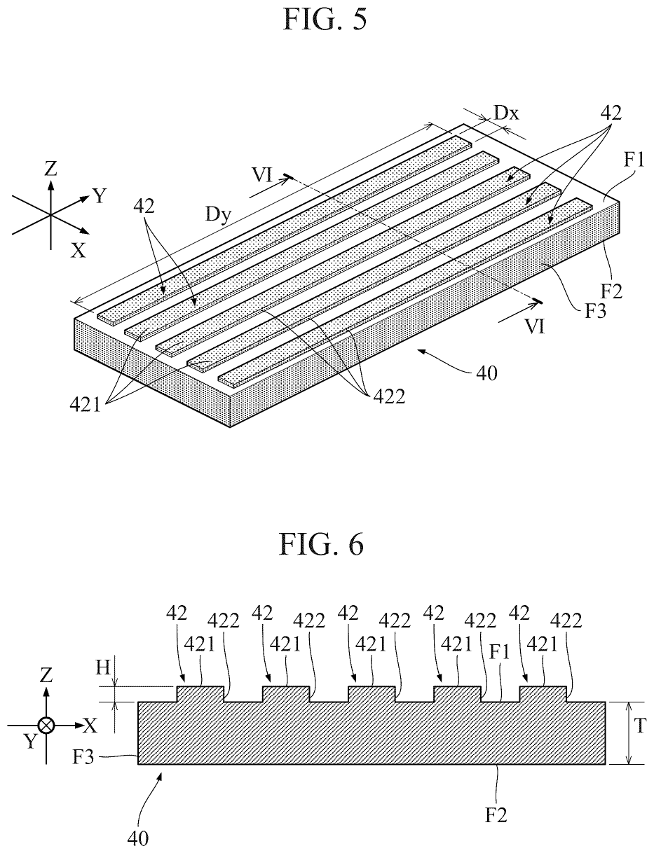

FIG. 5 is a perspective view of an exterior member 40 according to the second embodiment, and FIG. 6 is a cross-sectional view taken along line VI-VI shown in FIG. 5. The exterior member 40 according to the second embodiment is a structure in which the plurality of decorative portions 41 according to the first embodiment is substituted with a plurality of decorative portions 42. The exterior member 40 according to the second embodiment has the same configuration as the exterior member 40 according to the first embodiment, except for the plurality of decorative portions 42.

The base surface F1 of the exterior member 40 is provided with the plurality of decorative portions 42. The plurality of decorative portions 42 are each constituted of a protrusion from the base surface F1. Specifically, the plurality of decorative portions 42 each include a step surface 421 and a side wall surface 422. The step surface 421 of each of the plurality of decorative portions 42 is a top surface parallel to the X-Y plane at a level higher than the level of the base surface F1. The side wall surface 422 of each of the plurality of decorative portions 42 is an outer wall surface of the protrusion and is parallel to the Z-axis. The side wall surface 422 connects the base surface F1 and the step surface 421 to each other.

As in the first embodiment, a size H of a difference in level between the step surface 421 and the base surface F1 is greater than or equal to 1% of the thickness T of the exterior member 40 (H≥0.01 T). Specifically, the size H of the difference in level between the step surface 421 and the base surface F1 is greater than or equal to 5% of the thickness T of the exterior member 40 (H≥0.05 T), and is preferably greater than or equal to 10% of the thickness T of the exterior member 40 (H≥0.1 T). It is of note that in the second embodiment the size H of the difference in level between the step surface 421 and the base surface F1 is a height of each of the plurality of protrusions constituting the plurality of decorative portions 42 (a height difference between the base surface F1 and the step surface 421). In addition, an aspect ratio Dy/Dx of each of the plurality of decorative portions 42 is greater than or equal to 2.

A surface roughness of the step surface 421 of each of the plurality of decorative portions 42 and a surface roughness of the side wall surface 422 of each of the plurality of decorative portions 42 are greater than the surface roughness of the base surface F1. In other words, the step surface 421 and the side wall surface 422 of each of the plurality of decorative portions 42 are rougher than the base surface F1. As in the first embodiment, paint that includes a colorant is applied to an outer surface of the exterior member 40. Thus, as in the first embodiment, a degree of lightness of the step surface 421 of each of the plurality of decorative portions 42 and a degree of lightness of the side wall surface 422 of each of the plurality of decorative portions 42 are less than the degree of lightness of the base surface F1. In other words, a color tone of the step surface 421 and a color tone of the side wall surface 422 are closer to black than the color tone of the base surface F1.

As will be understood from the above description, the second embodiment provides the same effects as those provided by the first embodiment. For example, in the second embodiment, the plurality of decorative portions 42 are each elongated along the direction of the Y-axis, and the degree of lightness of the side wall surface 422 of each of the plurality of decorative portions 42 is less than the degree of lightness of the base surface F1. Thus, according to the second embodiment, as in the first embodiment, it is possible to maintain a uniformity of appearance by use of a configuration in which the longitudinal directions of the plurality of decorative portions 42 are uniform; and it is possible to realize a variety of design variations by a configuration in which the degree of lightness of the side wall surface 422 of each of the plurality of decorative portions 42 differs from the degree of lightness of the base surface F1.

### C: Third Embodiment

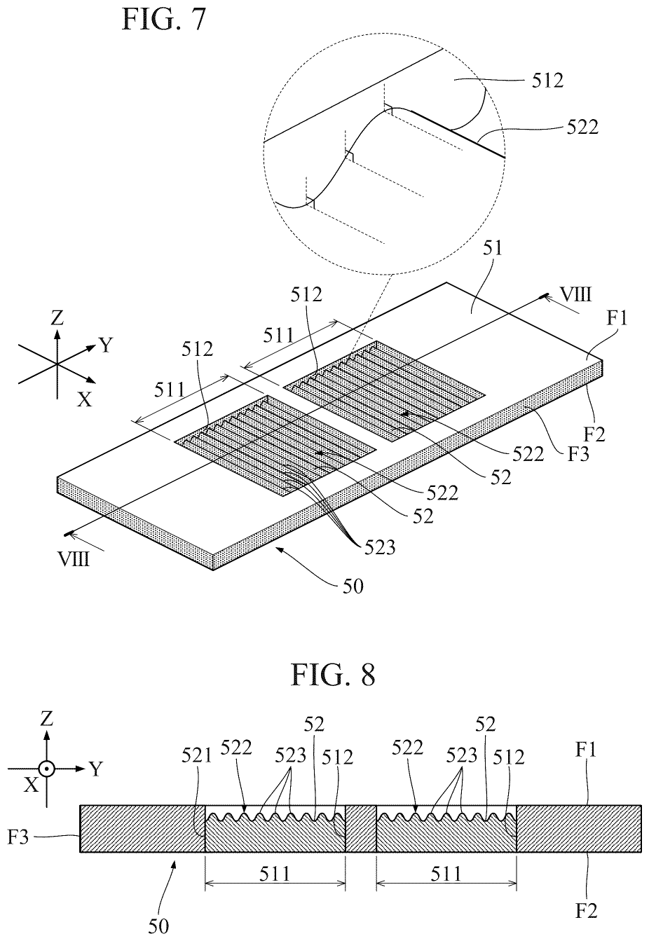

FIG. 7 is a perspective view of an exterior member 50 included in a keyboard musical instrument 100 according to a third embodiment. FIG. 8 is a cross-sectional view taken along line VIII-VIII shown in FIG. 7. The exterior member 50 is a plate-shaped member that constitutes a music stand 25 of the keyboard musical instrument 100. In other words, the keyboard musical instrument 100 includes the exterior member 50. The exterior member 50 is a plate-shaped member that is elongated in a longitudinal direction along the direction of the Y-axis.

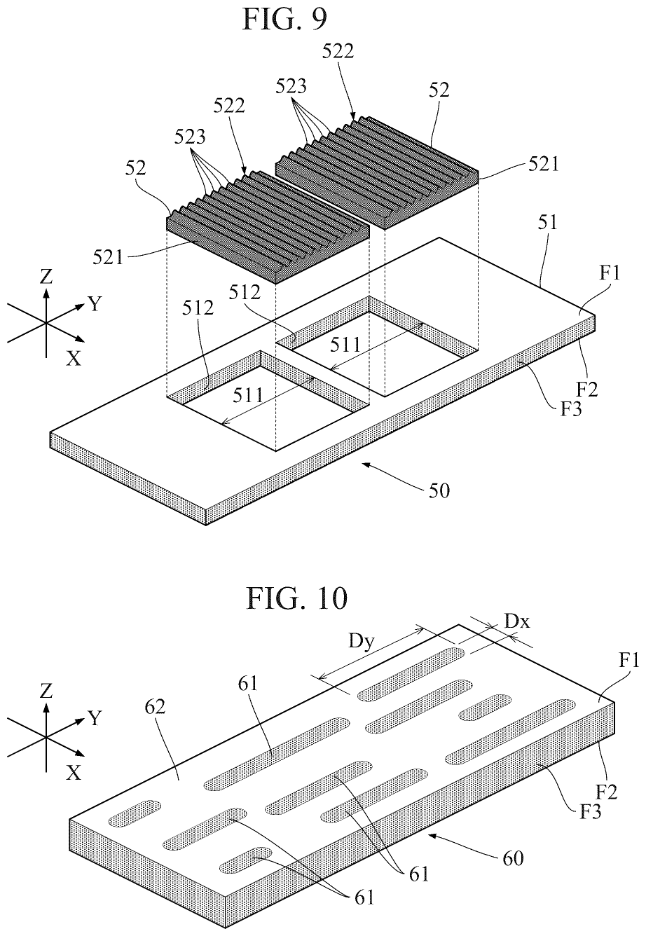

FIG. 9 is an exploded perspective view of the exterior member 50. The exterior member 50 includes a plate-shaped member 51 and a plurality of design members 52. Similarly to the exterior member 40 according to the first embodiment, the plate-shaped member 51 is in a form of an isotropic fiberboard, and each of the plurality of design members 52 is also in a form of an isotropic fiberboard. The exterior member 50 is an example of an isotropic fiberboard. The plate-shaped member 51 includes a base surface F1, a rear surface F2, and a side surface F3. Each of the base surface F1 and the rear surface F2 is a plane surface parallel to the X-Y plane.

The base surface F1 of the plate-shaped member 51 is provided with a plurality of openings 511, each of which is a through hole that is rectangular in shape in plan view. To form the plurality of openings 511, a cutter such as a rotary blade, for example, is used to partially remove a surface of a plate made of fiberboard. Thus, a surface roughness of an inner wall surface 512 of each of the plurality of openings 511 is greater than a surface roughness of the base surface F1. In other words, the inner wall surface 512 of each of the plurality of openings 511 is rougher than the base surface F1.

Paint containing a colorant is applied to the plate-shaped member 51. Thus, a degree of lightness of the inner wall surface 512 of each of the plurality of openings 511 is less than a degree of lightness of the base surface F1. In other words, a color tone of the inner wall surface 512 of each of the plurality of openings 511 is closer to black than a color tone of the base surface F1. In addition, a degree of average lightness of the side surface F3 of the plate-shaped member 51 is less than a degree of average lightness of the base surface F1. In other words, a color tone of the side surface F3 of the plate-shaped member 51 is closer to black than a color tone of the base surface F1.

The plurality of design members 52 are each fitted to a corresponding one of the plurality of openings 511 of the plate-shaped member 51. An outer shape of each and a size of each of the plurality of design members 52 are the same as an outer shape and a size of the corresponding one of the plurality of openings 511. Thus, an outer wall surface 521 of each of the plurality of design members 52 and the inner wall surface 512 of the corresponding one of the plurality of openings 511 are in close contact with each other without any gaps. It is of note that the plurality of openings 511 of the base surface F1 may each be a bottomed hole. In other words, a rear surface of each of the plurality of design members 52 and a bottom surface of the corresponding one of the plurality of openings 511 are in close contact with each other.

A surface of each of the plurality of design members 52 (hereinafter referred to as a “design surface 522”) is provided with a plurality of protrusions 523. The design surface 522 is a main surface having a normal line along the normal line of the base surface F1. The plurality of protrusions 523 each extend linearly along the X-axis. In other words, the plurality of protrusions 523 each extend parallel to the Y-axis from one side to the other side of the design member 52. The design surface 522 is a curved surface with a wave form that periodically repeats in the direction of the Y-axis. A top of each of the plurality of protrusions 523 is at a level lower than the level of the base surface F1. It is of note that when a portion of the design surface 522 interposed between adjacent two of the plurality of protrusions 523 is a recess, the design surface 522 has a wave-like form with multiple recesses extending along the X-axis in alignment with each other in the direction of the Y-axis. It is of note that the plurality of protrusions 523 may extend in the direction of the Y-axis.

To form the plurality of protrusions 523 of the design member 52, a cutter such as a rotary blade, for example, is used to partially remove a surface of a plate made of fiberboard. Thus, a surface roughness of the design surface 522 (a surface roughness of each of the plurality of protrusions 523) is greater than the surface roughness of the base surface F1. In other words, the design surface 522 is rougher than the base surface F1. In addition, paint is applied to the design surface 522 of the design member 52. Thus, a degree of lightness of the design surface 522 is less than a degree of lightness of the base surface F1. In other words, a color tone of the design surface 522 is closer to black than a color tone of the base surface F1.

As described above, according to the third embodiment, it is possible to realize a variety of designs in which the design surface 522, which has a degree of lightness that is less than a degree of lightness of the base surface F1, is provided with the plurality of protrusions 523. In addition, the plurality of design members 52 are each fitted to a corresponding one of the plurality of openings 511 of the base surface F1. Thus, for example, when a rotary blade is used to form both the plurality of openings 511 of the base surface F1 and the plurality of protrusions 523 of the design member 52, it is possible to produce a shape in which the inner wall surface 512 of each of the plurality of openings 511 of the base surface F1 and the design surface 522 of the design member 52 are in contact with each other at a desired angle. For example, as shown in FIG. 7 showing an enlarged view, a shape in which the inner wall surface 512 of each of the plurality of openings 511 and the surface of the design surface 522 are perpendicular to each other.

### D: Fourth Embodiment

FIG. 10 is a perspective view of an exterior member 60 included in the keyboard musical instrument 100. The exterior member 60 is a plate-shaped member. Each of the right leg 23 and the left leg 24 is constituted of the exterior member 60. In other words, the keyboard musical instrument 100 according to a fourth embodiment includes the exterior member 60. The exterior member 60 is a plate-shaped member that is elongated in a longitudinal direction along the direction of the Y-axis.

As with the exterior member 40 according to the first embodiment, the exterior member 60 is in a form of an isotropic fiberboard, and includes a base surface F1, a rear surface F2, and a side surface F3. The exterior member 60 is an example of an isotropic fiberboard. The base surface F1 is a main surface constituting an exterior. Paint including a colorant is applied to each of the surfaces of the exterior member 60. Thus, similarly to the exterior member 40 according to the first embodiment, a degree of average lightness of the side surface F3 of the exterior member 60 is less than a degree of average lightness of the base surface F1. In other words, a color tone of the side surface F3 of the exterior member 60 is closer to black than a color tone of the base surface F1.

The base surface F1 includes a plurality of regions, each of which has differing characteristics. Examples of such characteristics are differences in surface roughness and differences in hygroscopicity. These differences in characteristics (variations in characteristics) result in differences in permeation of paint among the plurality of regions of the base surface F1. In more detail, the base surface F1 is provided with a plurality of decorative portions 61 each of which has a surrounding region 62. The plurality of decorative portions 61 each constitute a portion of the base surface F1. The surrounding region 62 of each of the plurality of decorative portions 61 also constitutes a portion of the base surface F1.

The plurality of decorative portions 61 each constitute a portion of the base surface F1. An amount of paint that permeates the plurality of decorative portions 61 is more than an amount of paint that permeates the surrounding region 62. Thus, a degree of lightness of the plurality of decorative portions 61 is less than a degree of lightness of the surrounding region 62. In other words, a color tone of the plurality of decorative portions 61 is closer to black than a color tone of the surrounding region 62. As described above, the base surface F1 of the exterior member 60 according to the fourth embodiment includes the plurality of decorative portions 61 and the surrounding region 62, which differ in degree of lightness.

The paint is applied to the base surface F1 in the direction of the Y-axis. Specifically, the paint is applied to base surface F1 by movement in the direction of the Y-axis of a paint brush containing paint. Due to the direction in which the paint is applied (the direction of the Y-axis) and due to variations in characteristics of the base surface F1, in plan view, the plurality of decorative portions 61 are each elongated along the direction of the Y-axis. For example, given a size Dy of an outer shape of each of the plurality of decorative portions 61 in the direction of the Y-axis and a size Dx of the outer shape of each of the plurality of decorative portions 61 in the direction of the X-axis, an aspect ratio Dy/Dx, which is a ratio of the size Dy to the size Dx, is greater than or equal to two. As described above, longitudinal directions of the plurality of decorative portions 61 are parallel to each other. In other words, the longitudinal directions of the plurality of decorative portions 61 are uniform.

As described above, according to the fourth embodiment, it is possible to maintain a uniformity of appearance by a configuration in which the longitudinal directions of the plurality of decorative portions 61 are uniform; and it is possible to realize a variety of design variations by a configuration in which the degree of lightness of the plurality of decorative portions 61 differs from the degree of lightness of the base surface F1. In addition, although the exterior member 60 is in a form of an isotropic fiberboard, it is possible to realize a visual effect such that the exterior member 60 has an appearance of an anisotropic material.

It is of note that a configuration is described in which a boundary between the plurality of decorative portions 61 and the surrounding region 62 is clearly defined; however, the boundary between the plurality of decorative portions 61 and the surrounding region 62 need not be clearly defined. For example, a region in which a degree of lightness varies continuously in one direction may be disposed between the plurality of decorative portions 61 and the surrounding region 62.

It is of note that a support 2 of a keyboard musical instrument is commonly constituted of a plate made of fiberboard that is covered with a plastic material such as, for example, vinyl chloride. Thus, it is possible to realize a desired design by forming a variety of images on the plastic covering material. However, it is of note that use of a plastic covering material is detrimental to the environment. In this context, it is also of note that according to the first embodiment through the fourth embodiment, a variety of designs are realized without use of plastic materials, whereby an amount of plastic material used in construction of the keyboard musical instrument 100 compared to a conventional keyboard musical instrument is reduced. Thus, sustainability of the keyboard musical instrument 100 is enhanced and its impact on the environment is reduced.

### E: Fifth Embodiment

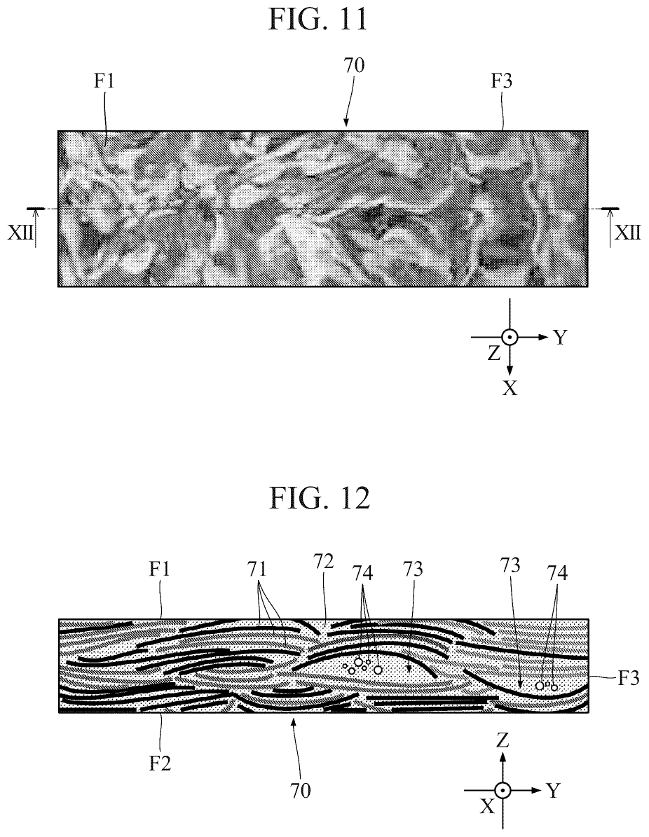

FIG. 11 is a plan view of an exterior member 70 included in a keyboard musical instrument 100 according to a fifth embodiment. FIG. 12 is a cross-sectional view taken along line XII-XII shown in FIG. 11. The exterior member 70 is a plate-shaped member included as an upper member 21 of the housing 20 of the keyboard musical instrument 100. In other words, the keyboard musical instrument 100 includes the exterior member 70. The exterior member 70 is a plate-shaped member that is elongated in a longitudinal direction along the direction of the Y-axis.

The exterior member 70 includes a base surface F1, a rear surface F2 that faces away from the base surface F1, and a side surface F3 that connects the base surface F1 and the rear surface F2 to each other. Each of the base surface F1 and the rear surface F2 is a plane surface parallel to the X-Y plane. The base surface F1 is a surface (exterior surface) that constitutes an exterior of the exterior member 70. For example, the exterior member 70 is disposed as the upper member 21 of the housing 20 such that a normal line of the base surface F1 faces upward in a vertical direction.

As shown in FIG. 12, the exterior member 70 is in a form of an oriented strand board (OSB) that includes a plurality of plate-shaped members 71 and a bonding material 72. The bonding material 72 is an adhesive used for adhering together the plurality of plate-shaped members 71. The plurality of plate-shaped members 71 are adhered such that they accumulate not only in a surface direction of the exterior member 70, but also in a direction of thickness of the exterior member 70. The surface direction of the exterior member 70 is a direction along either the X-axis or the Y-axis. The direction of thickness of the exterior member 70 is the direction along the Z-axis.

The plurality of plate-shaped members 71 is made of one or more types of wood-based materials. Specifically, the plurality of plate-shaped members 71 includes a plurality of wood-based materials of different tree species. For example, the plurality of plate-shaped members 71 are each made of a wood-based material of a tree species such as spruce, Ezo spruce, Agathis, maple, kava, Mansonia altissima, sapele, Australian blackwood, ebony, rosewood, Honduran rosewood, African padauk, granadilla, Pao rosa, walnut, sono keling, ash, ovangkol, olive, or eucalyptus. According to this embodiment, it is possible to realize a texture of the exterior member 70 that is particular to the wood-based material. Furthermore, in the configuration according to the fifth embodiment the exterior member 70 includes a plurality of wood-based materials of the different tree species. As a result a rich variety of designs can be provided with textures unique to corresponding ones of the plurality of tree species.

The plurality of plate-shaped members 71 are each a thin plate-shaped wood piece having an average thickness that is less than 1 mm. More specifically, the average thickness of the plate-shaped member 71 is less than 0.5 mm, and preferably is less than or equal to 0.2 mm. The plurality of plate-shaped members 71 is sufficiently thin such that it can deform into a curved shape. Consequently, it is possible to realize an exterior member 70 that has an exterior surface with an appearance of multiple curved lines corresponding to curves of two or more of the plurality of plate-shaped members 71.

The plurality of plate-shaped members 71 are joined together such that each of the plurality of plate-shaped members 71 has an irregular three-dimensional shape. For example, the plurality of plate-shaped members 71 includes not only at least one of the plurality of plate-shaped members 71 that maintains a shape of a flat plate and is joined to another of the plurality of plate-shaped members 71, but also includes at least one of the plurality of plate-shaped members 71 that deforms and curves to form a curved surface and is joined to another of the plurality of plate-shaped members 71. As shown in FIG. 12, the bonding material 72 is provided in spaces, each of which is a space (hereinafter referred to as a “storage space 73”) between the at least one of the plurality of plate-shaped members 71 and at least one of the plurality of plate-shaped members 71. In addition, one or more air bubbles 74 are disposed in the bonding material 72 provided in the storage space 73. The bonding material 72 is, for example, a light-permeable adhesive. For example, the bonding material 72 is constituted of a resin material such as an epoxy-based resin or of an acrylic-based resin. In addition, the bonding material 72 includes a colorant. For example, the bonding material 72 includes a black dye as the colorant. The bonding material 72 described above is translucent and contains a black colorant. However, it is of note that the bonding material 72 may be constituted of a transparent material that contains no colorant.

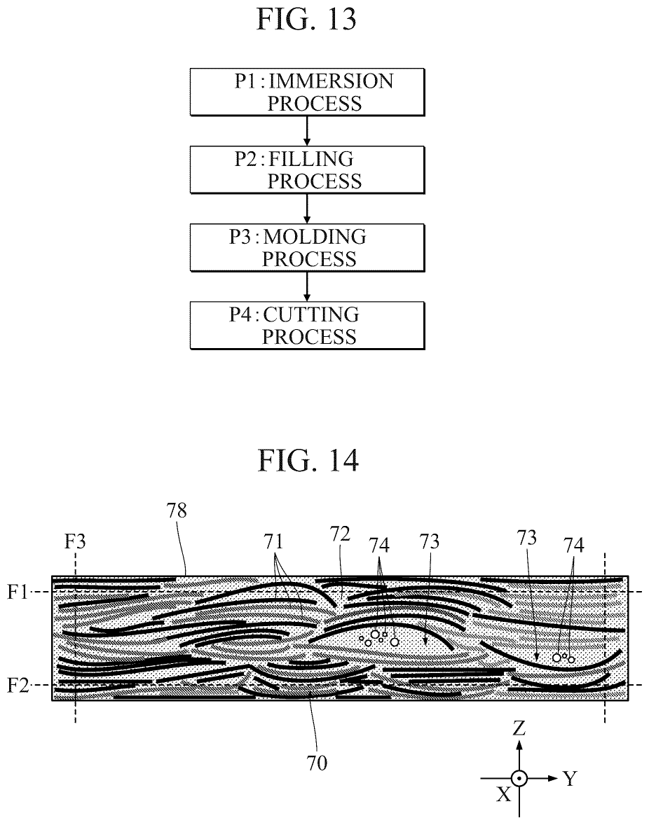

FIG. 13 is a flowchart of a process for producing the exterior member 70 according to the fifth embodiment. First, in an immersion process P1, the plurality of plate-shaped members 71 is immersed in and impregnated with a liquid resin material. The liquid resin material may serve as the bonding material 72. Specifically, the liquid resin material permeates small holes in a surface of each of the plurality of plate-shaped members 71. Thus, compared to a configuration in which the bonding material 72 is in contact with only a surface of each of the plurality of plate-shaped members 71, it is possible to more securely join together the plurality of plate-shaped members 71 in the exterior member 70.

After the immersion process P1, in a filling process P2 the plurality of plate-shaped members 71 impregnated with the liquid resin material is filled to accumulate irregularly in a mold. After the filling process P2, by a molding process P3 a flat plate-shaped molded body 78 shown in FIG. 14 is formed. In the molding process P3, the interior of the mold is pressurized for curing of the bonding material 72. The mold is then opened to provide the molded body 78. Application of pressure during the molding process P3, causes the plurality of plate-shaped members 71 to be pressed against each other, and at least one of the plurality of plate-shaped members 71 to deform and curve. Thus, the at least one of the plurality of plate-shaped members 71 that deforms and curves has a curved surface.

After the molding process P3, in a cutting process P4 the molded body 78 is cut to provide the exterior member 70. During the cutting process P4, for example, the side surface F3 of the exterior member 70 is formed by cutting a side surface of the molded body 78. Thus, as shown in FIG. 12 and in FIG. 14, the side surface F3 of the exterior member 70 is provided with cut surfaces of two or more of the plurality of plate-shaped members 71. Specifically, in the side surface F3 of the exterior member 70 the two or more of the plurality of plate-shaped members 71 that accumulate are curved and have a curved surface.

In addition, as shown in FIG. 14, the base surface F1 of the exterior member 70 is formed by cutting an upper surface of the molded body 78, and the rear surface F2 of the exterior member 70 is formed by cutting a lower surface of the molded body 78. Thus, as shown in FIG. 11 and in FIG. 12, each of the base surface F1 and the rear surface F2 of the exterior member 70 is provided with cut surfaces of two or more of the plurality of plate-shaped members 71. Specifically, each of the base surface F1 and the rear surface F2 of the exterior member 70 includes multiple irregular curved lines, which are constituted of cut surfaces of the two or more of the plurality of plate-shaped members 71, or include multiple irregular bent lines, which are constituted of cut surfaces of the two or more of the plurality of plate-shaped members 71. As described above, the exterior surface of the exterior member 70 (each of the base surface F1, the rear surface F2, and the side surface F3) is provided with a cut surface of at least one of the plurality of plate-shaped members 71 constituting the exterior member 70.

As described above, in the fifth embodiment, at least one of the plurality of plate-shaped members 71 included in the exterior member 70 is joined to another of the plurality of plate-shaped members 71, with the at least one of the plurality of plate-shaped members 71 being curved. Thus, compared to a configuration in which the plurality of plate-shaped members 71 are accumulated and joined together, with each of the plurality of plate-shaped members 71 maintaining a shape of a flat plate (a configuration in which a cut surface of the exterior member 70 is in simple layers), it is possible to realize a variety of designs that include a mix of straight lines and curved lines in a cut surface of the exterior member 70. In particular, in the fifth embodiment a configuration is provided in which the exterior surface of the exterior member 70 has a cut surface of the at least one of the plurality of plate-shaped members 71 that is curved. Thus, it is possible to realize a variety of designs that include a non-uniform mix of straight lines and curved lines in the exterior surface of the exterior member 70.

Furthermore, in the fifth embodiment, the bonding material 72 is provided in the storage space 73 between the at least one of the plurality of plate-shaped members 71 that is curved and another of the plurality of plate-shaped members 71. Thus, the cut surface of the exterior member 70 is provided with a cut surface of the bonding material 72. Consequently, it is possible to realize in the exterior member 70 a cut surface that has a complicated pattern. The complicated pattern includes the cross surface of the bonding material 72, the straight lines being constituted of the two or more of the plurality of plate-shaped members 71, and the curved lines constituted of the two or more of the plurality of plate-shaped members 71. Furthermore, in the fifth embodiment, one or more air bubbles 74 are present the bonding material 72 provided in the storage space 73. Thus, it is possible to realize the exterior member 70 that includes a cut surface having a complicated pattern. The complicated pattern includes the one or more bubbles 74 present in the storage space 73, the straight lines constituted of two or more of the plurality of plate-shaped members 71, the curved lines constituted of two or more of the plurality of plate-shaped members 71, and the cross surface of the bonding material 72.

In the fifth embodiment, the bonding material 72 is light permeable. Thus, it is possible to realize a design in which accumulation of the two or more of the plurality of plate-shaped members 71 is visually pronounced. Furthermore, the bonding material 72 includes the colorant. Thus, it is possible to realize the exterior member 70 having a distinctive appearance in which the bonding material 72 is readily visible.

### F: Sixth Embodiment

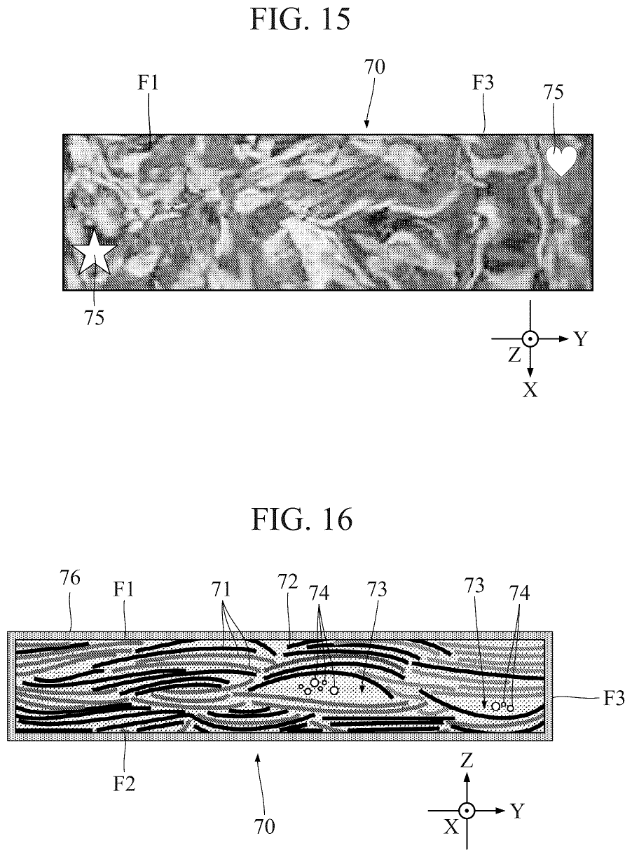

FIG. 15 is a plan view of an exterior member 70 according to a sixth embodiment. The exterior member 70 according to the sixth embodiment includes at least one decorative member 75, in addition to elements that have the same configuration as those included in the fifth embodiment (the plurality of plate-shaped members 71 and the bonding material 72). The at least one decorative member 75 is a flat plate-shaped member that is used to provide distinctive decoration of the exterior member 70. Specifically, the at least one decorative member 75 is an artificial object that has a predetermined shape and is made of, for example, a plastic. It is of note that the at least one decorative member 75 may be a natural object such as a leaf or a flower of a plant, for example. The at least one decorative member 75 is bonded by the bonding material 72 to a part of the plurality of plate-shaped members 71. Specifically, the at least one decorative member 75 is embedded in the exterior member 70 such that the at least one decorative member 75 is substantially parallel to the base surface F1.

The at least one decorative member 75 is disposed in a portion of the exterior member 70 close to the base surface F1. In addition, as in the fifth embodiment, the bonding material 72 is light permeable. Thus, the at least one decorative member 75 embedded in the exterior member 70 is readily visible to the player of the keyboard musical instrument 100.

A relationship between an area A1 of the base surface F1 of the exterior member 70 and a projected area A2 of the at least one decorative member 75 on the base surface F1 (the X-Y plane) will be described below. A ratio A2/A1 is a ratio of the projected area A2 of the at least one decorative member 75 to the area A1 of the base surface F1, and is less than or equal to 0.5. More specifically, the ratio A2/A1 is less than or equal to 0.3. More preferably, the ratio A2/A1 is less than or equal to 0.1.

In the sixth embodiment, elements other than the at least one decorative member 75 have the same configuration as those in the fifth embodiment. Thus, the sixth embodiment provides the same effects as those provided by the fifth embodiment. Furthermore, in the sixth embodiment, the exterior member 70 includes the at least one decorative member 75, in addition to the plurality of plate-shaped members 71 and the bonding material 72. Thus, it is possible to realize a distinctive design in which the at least one artificial or natural decorative member 75 is included in a mix of non-uniformly accumulated ones of the plurality of plate-shaped members 71. In addition, the ratio A2/A1, which is the ratio of the projected area A2 of the at least one decorative member 75 to the area A1 of the base surface F1 (main surface) of the exterior member 70, is less than or equal to 0.5. Thus, compared to a configuration in which an excessive number of the plurality of decorative members 75 is disposed, it is possible to realize a unique design in which the at least one decorative member 75 is particularly emphasized.

### G: Seventh Embodiment

FIG. 16 is a plan view of an exterior member 70 according to a seventh embodiment. In the seventh embodiment, a covering layer 76 is provided that covers the base surface F1, which is an outer layer of the exterior member 70. The covering layer 76 is a covering layer constituted of a light permeable resin material. For example, the covering layer 76 is constituted of an epoxy-based resin material or of an acrylic-based resin material. The covering layer 76 does not include a colorant. In other words, the covering layer 76 is constituted of a colorless transparent material. The covering layer 76 may be formed, for example, by curing a liquid resin material that is applied to the base surface F1. Alternatively, the covering layer 76 may be formed to have a sheet-type shape and joined to the base surface F1, for example.

In the seventh embodiment, elements other than the covering layer 76 have the same configuration as those of the fifth embodiment. Thus, the seventh embodiment provides the same effects as those provided by the fifth embodiment. It is of note that in the fifth embodiment, the base surface F1 may be provided with irregularities constituted of outer shapes of two or more of the plurality of plate-shaped members 71. In contrast, in the seventh embodiment, the base surface F1 is covered by the covering layer 76. Thus, it is possible to even out the irregularities in the base surface F1 constituted of the two or more of the plurality of plate-shaped members 71.

It is of note that in each of the first embodiment through the seventh embodiment, a difference in “degree of lightness” of members is caused by a difference in degree of reflection of surfaces of the members. In addition, a difference in degree of reflection of members is caused by a difference in color tone of the surfaces of the members, for example. “A color tone” may be affected by any one of three properties including a degree of lightness (value), a degree of saturation (chroma), and a hue, or alternatively, “a color tone” is affected by a combination of two or more properties among the three properties. Thus, “a difference in color tone” between members means that there is a difference in one or more properties among the three properties, which include a degree of lightness (value), a degree of saturation (chroma), and a hue; or alternatively, “a difference in color tone” between members means that there is a difference in a degree of reflection relative to color tone between the members. As described above, each of the properties (a degree of lightness, a degree of saturation, or a hue) that affect a color tone has a correlation with a degree of reflection. Thus, in this disclosure, “a color tone (for example, a degree of lightness, a degree of saturation, or a hue)” can be expressed as “a degree of reflection,” or alternatively, “a degree of reflection” can be expressed as “a color tone (for example, a degree of lightness, a degree of saturation, or a hue).”

### H: Eighth Embodiment

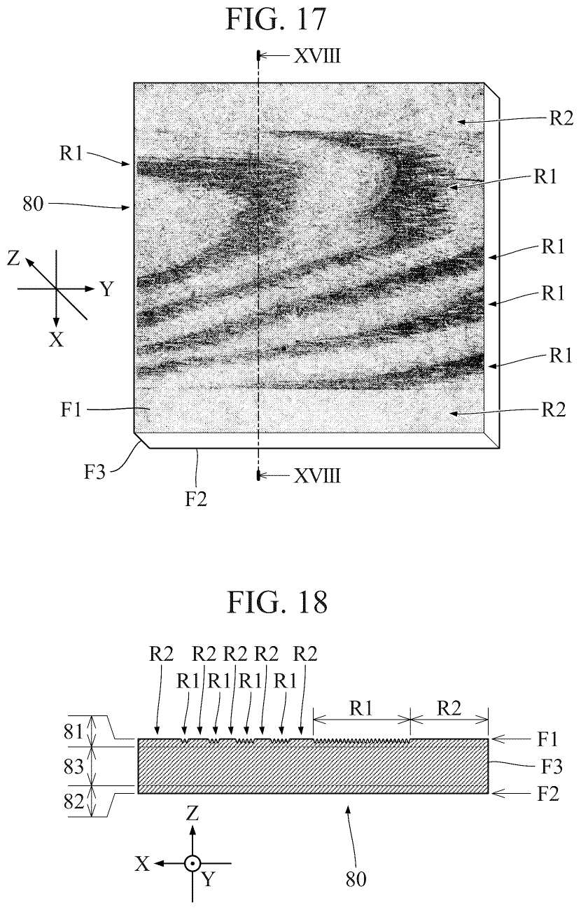

FIG. 17 is a perspective view of an exterior member 80 according to an eighth embodiment, and FIG. 18 is a cross-sectional view taken along line XVIII-XVIII shown in FIG. 17. The exterior member 80 is a plate-shaped member included as any one of the elements (the housing 20, the right leg 23, the left leg 24, and the music stand 25) that constitute a keyboard musical instrument 100. In other words, the keyboard musical instrument 100 includes the exterior member 80.

The exterior member 80 includes a base surface F1, a rear surface F2 that faces away from the base surface F1, and a side surface F3 that connects the base surface F1 and the rear surface F2 to each other. Each of the base surface F1 and the rear surface F2 is a plane surface parallel to the X-Y plane. The base surface F1 is a surface (exterior surface) that constitutes an exterior of the exterior member 80. For example, the exterior member 80 is disposed as the upper member 21 of the housing 20 such that a normal line of the base surface F1 faces upward in the vertical direction.

The exterior member 80 according to the eighth embodiment is in a form of an isotropic fiberboard. The exterior member 80 is an example of an isotropic fiberboard. The fiberboard is a plate-shaped member formed by heating and pressurizing fibers of a wood-based material, such that the fibers of the wood-based material are molded together into a desired shape. Specifically, the exterior member 80 is constituted of fiberboard such as medium density fiberboard (MDF), hardboard, or insulation board. As described above, the exterior member 80 includes the wood-based material.

The wood-based material is constituted of material made from small pieces of wood of trees. For example, the wood-based material may be constituted of only small pieces of wood, such as a wood flour, or alternatively, the wood-based material may be constituted of a mixture of small pieces of wood and a resin material (for example, a synthetic resin). For example, to form the exterior member 80, a wood-based material is used that made from small pieces of lumber of a tree species such as spruce, Ezo spruce, Agathis, maple, kava, Mansonia altissima, sapele, Australian blackwood, ebony, rosewood, Honduran rosewood, African padauk, granadilla, Pao rosa, walnut, sono keling, ash, ovangkol, olive, or eucalyptus.

As shown in FIG. 18, the exterior member 80 includes a first surface layer 81, a second surface layer 82, and an intermediate layer 83. The intermediate layer 83 is interposed between the first surface layer 81 and the second surface layer 82. An outer surface of the first surface layer 81 is the base surface F1, and an outer surface of the second surface layer 82 is the rear surface F2.

The fiberboard constituting the exterior member 80 is produced by pressing together a mixture of accumulated fibers of the wood-based material and the resin material (for example, the synthetic resin) in the direction of the Z-axis. In other words, the base surface F1 and the rear surface F2 are formed by a flat jig pressing the base surface F1 and the rear surface F2. Each of the first surface layer 81 and the second surface layer 82 is a section in which the wood-based material is accumulated in higher density under pressure during the production process of the exterior member 80 than in the intermediate layer 83. Since the wood-based material is accumulated in high density, each of the first surface layer 81 and the second surface layer 82 is harder than the intermediate layer 83. In addition, each of the first surface layer 81 and the second surface layer 82 has a lower hygroscopicity than the intermediate layer 83.

The base surface F1 includes a first region R1 and a second region R2. A combination of the first region R1 and the second region R2 creates a pattern imitative of a wood grain of a wood-based material (for example, a cross grain or a straight grain). As shown in FIG. 18, an area of the first region R1 is smaller than an area of the second region R2. However, the area of the first region R1 need not be smaller than the area of the second region R2. For example, a configuration can be assumed in which the area of the first region R1 is larger than the area of the second region R2, or alternatively, a configuration can be assumed in which the area of the first region R1 is equal in size to the area of the second region R2.

A surface condition of the first region R1 differs from a surface condition of the second region R2. The surface condition of the first region R1 denotes a structural or optical characteristic of a surface of first region R1, and the surface condition of the second region R2 denotes a structural or optical characteristic of a surface of the second region R2. A difference between a surface condition of the first region R1 and that of the second region R2 will be described below.

First, a surface roughness of the first region R1 differs from a surface roughness of the second region R2. A surface roughness is an index of roughness (in other words, a magnitude of unevenness) of an outer surface of the exterior member 80. A surface roughness is, for example, an arithmetic mean roughness Ra, a maximum height Ry, or a ten-point height of irregularities Rz. The surface roughness of the first region R1 is an average surface roughness of the entire area of the first region R1. The surface roughness of the second region R2 is an average surface roughness of the entire area of the second region R2.

Specifically, the surface roughness of the first region R1 is greater than the surface roughness of the second region R2. For example, the first region R1 is a rough surface provided with fine protrusions and fine recesses, and the second region R2 is a smooth surface that is flatter than the first region R1.

A depth of each of the recesses (or a height of each of the protrusions) of the first region R1 is less than a thickness of the first surface layer 81. In other words, the recesses and the protrusions of the first region R1 are provided in the outer surface of the first surface layer 81, and a bottom of each of the recesses is disposed apart from the intermediate layer 83. Thus, the intermediate layer 83 is not exposed at the base surface F1. As described above, the intermediate layer 83 is of low density and has high hygroscopicity compared to each of the first surface layer 81 and the second surface layer 82. Thus, in a configuration in which the bottom of each of the recesses of the first region R1 is disposed in the intermediate layer 83, a portion of the intermediate layer 83, which is exposed at the base surface F1, is prone to absorb moisture. On the other hand, in a configuration in which the intermediate layer 83 is not exposed at the base surface F1 as shown in FIG. 18, it is possible to substantially prevent the exterior member 80 (in particular, the intermediate layer 83) from absorbing excessive moisture.

Furthermore, in the exterior member 80 according to the eighth embodiment, a degree of reflection of the first region R1 differs from a degree of reflection of the second region R2. For example, the degree of reflection of the first region R1 is less than the degree of reflection of the second region R2. The degree of reflection of each of the first region R1 and the second region R2 is related to a degree of lightness of an outer surface of the exterior member 80. For example, a ratio of an amount of light reflected by an outer surface of the exterior member 80 to an amount of light received by the outer surface of the exterior member 80 is an example of “a degree of reflection.”

The degree of reflection of the first region R1 is a degree of average reflection of the entire area of the first region R1, and the degree of reflection of the second region R2 is a degree of average reflection of the entire area of the second region R2.

A difference between the degree of reflection of the first region R1 and the degree of reflection of the second region R2 is caused by at least a difference between the degree of lightness of the first region R1 and the degree of lightness of the second region R2. For example, the degree of lightness of the first region R1 is less than the degree of lightness of the second region R2. In other words, the color tone of the first region R1 is closer to black than the color tone of the second region R2. In the eighth embodiment, the difference in the degree of reflection between the first region R1 and the second region R2 is caused by the difference in surface roughness between the first region R1 and the second region R2. In other words, light received by the first region R1 is subject to scattering when reflected from the rougher surface of the first region R1. Thus, the degree of reflection of the first region R1 is less than the degree of reflection of the second region R2.

In addition, paint is applied to the exterior member 80. Specifically, the paint is applied to the base surface F1 of the exterior member 80. The base surface F1 is an example of a painted surface. It is of note that that in addition to the base surface F1 the paint may be applied to either the rear surface F2 or the side surface F3. The paint applied to the exterior member 80 is, for example, a permeating resin material such as a wax or an oil. The paint includes a colorant. The colorant is, for example, a black pigment or a black dye. It is of note that the paint applied to the exterior member 80 may be transparent and include no colorant.

A removal process is carried out after application of the paint to the exterior member 80 (for example, a painting process Qb described below), to remove excessive paint from the base surface F1. A tool such as a highly hard spatula, for example, is used in the removal process. As a result of carrying out the removal process, a level of the surface of the first region R1 becomes lower than a level of the surface of the second region R2. After completion of the removal process, more paint remains on the first region R1 than remains on the second region R2.

The recesses in the first region R1, which comprise the rough surface, retain more of the applied paint. Thus, after completion of the removal process more paint remains on the first region R1 than remains on the second region R2. Since the paint includes the colorant, a degree of reflection of a surface decreases with an increase in amount of paint remaining on the surface. As described above, the difference in degree of reflection between the first region R1 and the second region R2 is caused by not only the difference in surface roughness, but also by a difference in an amount of remaining paint. In other words, according to the eighth embodiment, due to the difference in amount of paint remaining on the first region R1 compared to that remaining on the second region R2, a difference in the degree of reflection between the first region R1 and the second region R2 can be easily realized.

It is of note that a configuration is described in which the difference between the degree of lightness of the first region R1 and that of the second region R2 is caused by the difference between the amount of paint that remains on first region R1 and that remains on the second region R2; however, the difference in degree of lightness between the first region R1 and the second region R2 may be caused by a difference between a color tone of a paint applied on the first region R1 and that of a paint applied on the second region R2, for example. A color tone is affected by any one of three properties, namely, a degree of lightness (value), a degree of saturation (chroma), and a hue, or alternatively, a color tone is affected by a combination of two or more properties among the three properties.

As described above, in the eighth embodiment, the first region R1 differs in surface roughness and in degree of reflection from the second region R2. Thus, it is possible to realize a variety of designs with varying appearances. In particular, in the configuration according to the eighth embodiment, the area of the first region R1 is smaller than the area of the second region R2. Thus, for example, compared to a configuration in which the area of the first region R1 is equal to the area of the second region R2, it is possible to realize a variety of designs with varying appearances.

It is of note that in the above description a configuration is described in which a boundary between the first region R1 and the second region R2 is clearly defined; however, the boundary between the first region R1 and the second region R2 need not be clearly defined. For example, a region in which a surface roughness and a degree of reflection vary continuously in a direction may be disposed between the first region R1 and the second region R2. Furthermore, in the above description, a configuration is described in which the difference between the degree of reflection of the first region R1 and that of the second region R2 is caused by the difference in surface roughness between the first region R1 and the second region R2 together with the difference between the amount of paint that remains on the first region R1 and that remains on the second region R2. However, a cause of the difference between the degree of reflection of the first region R1 and that of second region R2, and a configuration in which the difference between the degree of reflection of the first region R1 and that of the second region R2 are not limited to the example described above.

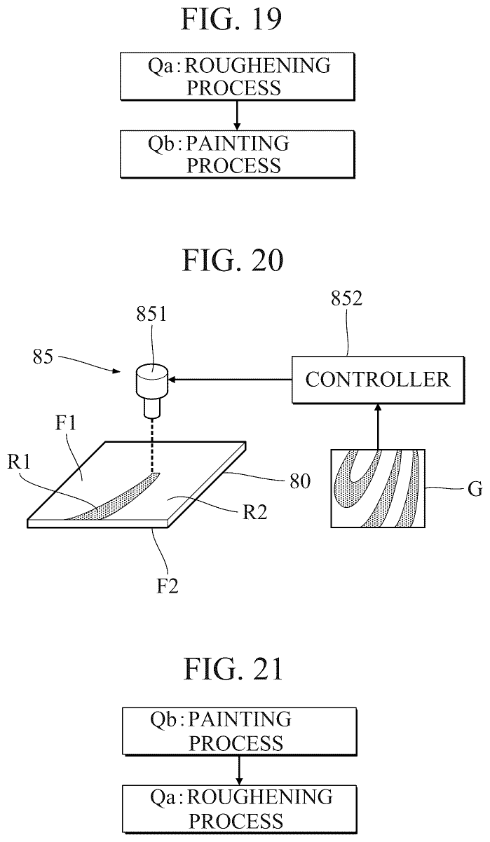

FIG. 19 is a flowchart of a process for producing the exterior member 80 according to the eighth embodiment. First, at a roughening process Qa, the first region R1 of the base surface F1 of the exterior member 80 is roughened. Specifically, during the roughening process Qa, the first region R1 is roughened by irradiation of the first region R1 with a laser beam. The second region R2 of the base surface F1 is not irradiated with the laser beam, and thus the second region R2 retains a flat surface.

FIG. 20 is an explanatory diagram showing the roughening process Qa. In the roughening process Qa, a processing machine 85 shown in FIG. 20 is used. The processing machine 85 includes a laser 851 and a controller 852. The laser 851 emits the laser beam to the base surface F1 of the exterior member 80.

The controller 852 controls the direction of the laser beam emitted by the laser 851. The controller 852 receives data indicative of a material image G. The material image G is an image to be drawn on the base surface F1 of the exterior member 80. The material image G is a binary bitmap image representative of wood grain, for example. The controller 852 controls the laser 851 such that the laser beam is directed to a portion of the base surface F1 corresponding to a dark color region (for example, a black region) of the material image G, while no laser beam is directed to the other portion of the base surface F1 corresponding to a light color region (for example, a white region) of the material image G. The laser beam removes minute parts from the portion of the base surface F1, thereby roughening the portion of the first region R1. In addition, the regions of the base surface F1, to which the laser beam is directed, are heated and burned. In other words, a color of the first region R1 changes to a dark brown color due to burning caused by irradiation with the laser beam. The difference between the degree of lightness of the first region R1 and that of the second region R2 is caused by the dark brown color caused by burning by irradiation with the laser beam.

As shown in FIG. 19, at the painting process Qb carried out after the roughening process Qa, paint is applied to the base surface F1. Specifically, the paint is applied to both the first region R1 and the second region R2 of the base surface F1.

As described above, in the eighth embodiment, the laser beam is directed to the base surface F1, and the paint is applied to the base surface F1. Thus, it is possible to easily create both a difference in surface roughness and a difference in degree of reflection between the first region R1 of the base surface F1 and the second region R2 of the base surface F1. Furthermore, in the eighth embodiment, the first region R1 is rougher than the second region R2, and thus the degree of reflection of the first region R1 is less than the degree of reflection of the second region R2. Thus, by a simple process of roughening the first region R1, it is possible to reduce the degree of reflection of the first region R1.

It is of note that in the configuration described according to the eighth embodiment, the painting process Qb is carried out after the roughening process Qa; however, the roughening process Qa and the painting process Qb may be carried out in reverse order. In other words, as shown in FIG. 21, the roughening process Qa may be carried out after the painting process Qb. When a laser beam is directed to the base surface F1 during the roughening process Qa, a part of the paint applied to the base surface F1 during the painting process Qb is removed. Thus, an exterior member 90 may be formed in which the degree of reflection of the second region R2 is less than the degree of reflection of the first region R1.

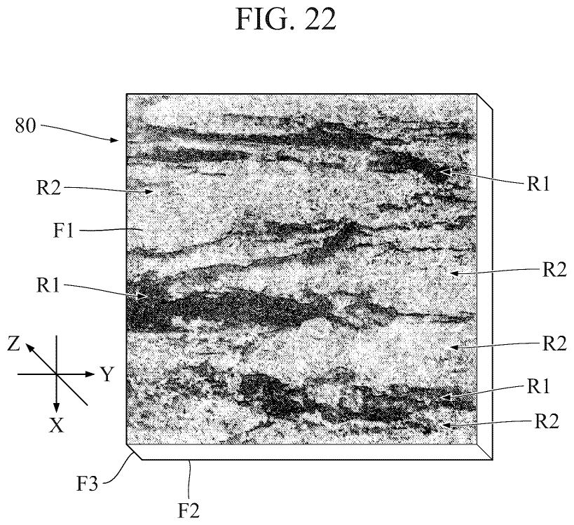

Furthermore, in the eighth embodiment, an appearance of the wood grain of a wood-based material (for example, cross grain or straight grain) is created by a combination of the first region R1 and the second region R2. However, a pattern formed on the base surface F1 is not limited to the example described above. For example, as shown in FIG. 22, the combination of the first region R1 and the second region R2 may create a pattern imitative of a bark of a wood-based material. As described above, a pattern of a wood-based material is created by the combination of the first region R1 and the second region R2.

The pattern formed on the base surface F1 is not limited to a pattern related to a wood-based material (for example, a grain or a bark). For example, a pattern of a natural object other than a wood-based material can be formed on the base surface F1 by a combination of the first region R1 and the second region R2. For example, one or more types of patterns imitative of an appearance of a natural object such as a pattern imitative of a rock such as marble, a pattern imitative of a part of a creature such as a shell or a feather, or a pattern imitative of a part of a plant such as a branch, a leaf, or a flower, may be formed on the base surface F1.

### I: Ninth Embodiment

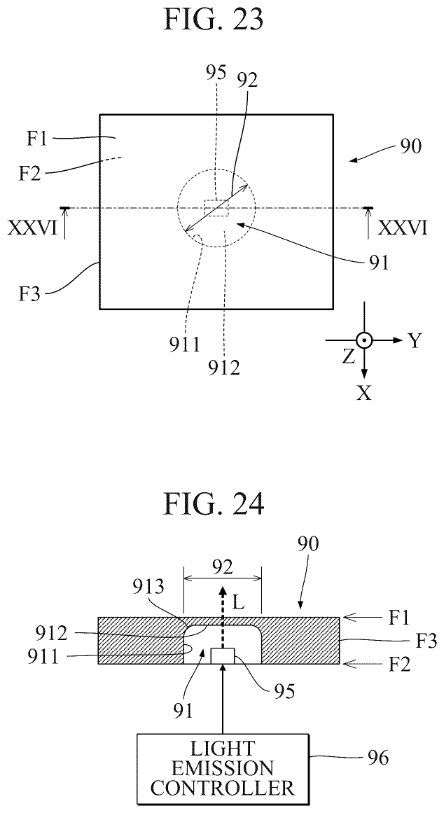

FIG. 23 is a plan view of an exterior member 90 according to a ninth embodiment. FIG. 24 is a cross-sectional view taken along line XXVI-XXVI shown in FIG. 23. The exterior member 90 is a plate-shaped member included as any one of elements (the housing 20, the right leg 23, the left leg 24, and the music stand 25) that constitute a keyboard musical instrument 100. In other words, the keyboard musical instrument 100 includes the exterior member 90.

Similar to the exterior member 80 according to the eighth embodiment, the exterior member 90 is in a form of an isotropic fiberboard. The exterior member 90 is an example of an isotropic fiberboard. The exterior member 90 includes a base surface F1, a rear surface F2 that faces away from the base surface F1, and a side surface F3 that connects the base surface F1 and the rear surface F2 to each other. As in the eighth embodiment, the base surface F1 includes a first region R1 and a second region R2. However, in FIG. 23 and in FIG. 24, for convenience of illustration, the first region R1 and the second region R2 are omitted.

The rear surface F2 of the exterior member 90 includes a recess 91. The recess 91 is a hollow in the rear surface F2. The recess 91 may be formed, for example, by partially cutting away the rear surface F2 of the exterior of the flat plate-shaped member 90, or by partially pressurizing the rear surface F2 of the exterior of the flat plate-shaped member 90. Alternatively, when forming the exterior member 90, the rear surface F2 may be subject to pressure by use of a processing surface that includes a cylindrical protrusion, thereby forming the recess 91 to correspond to the protrusion. It is of note that in FIG. 23 a configuration is shown in which a planar shape of the recess 91 is circular; however, the planar shape of the recess 91 may be freely changed, as appropriate. For example, the planar shape of the recess 91 may be polygonal, elliptical, oval, linear, or curved.

The recess 91 is a space defined by a cylindrical inner wall surface 911 and a planar bottom surface 912. The exterior member 90 has a portion (hereinafter referred to as a “thin plate portion 92”) interposed between the base surface F1 and the bottom surface 912. In plan view, the thin plate portion 92 is a circular portion corresponding to the recess 91. A thickness of the thin plate portion 92 of the exterior member 90 is less than a thickness of a portion of the exterior member 90 other than the thin plate portion 92. In other words, the thin plate portion 92 is a portion of the exterior member 90 that has a thickness obtained by subtracting a depth of the recess 91 from a thickness of the portion of the exterior member 90 other than the thin plate portion 92.

In addition, the inner wall surface 911 and the bottom surface 912 are connected to each other through an arcuate curved surface 913 (R-shaped curved surface 913). According to the above configuration, compared to a configuration in which the inner wall surface 911 and the bottom surface 912 are directly connected to each other at an angle, it is possible to substantially prevent stress from being concentrated at a peripheral portion of the bottom surface 912. Thus, an advantage is realized in that it is easy to maintain a mechanical strength of the thin plate portion 92. However, the inner wall surface 911 and the bottom surface 912 may be directly connected to each other, as appropriate. In other words, the curved surface 913 may be omitted.

As shown in FIG. 24, the keyboard musical instrument 100 according to the ninth embodiment includes a light emitter 95 and a light emission controller 96. The light emitter 95 is a light source configured to emit an illumination light L. An example of the light emitter 95 is a light-emitting element such as a light-emitting diode. The illumination light L is, for example, white light.

In plan view, the light emitter 95 is disposed within the recess 91. In other words, in plan view, the light emitter 95 is surrounded by the inner wall surface 911 of the recess 91. Furthermore, in the direction of the Z-axis, the light emitter 95 is disposed between the base surface F1 and the rear surface F2.

The illumination light L emitted by the light emitter 95 travels from inside the recess 91 toward the thin plate portion 92 and passes through the thin plate portion 92. In other words, the illumination light L enters the thin plate portion 92 from the bottom surface 912 of the recess 91 and travels through the exterior member 90 toward the base surface F1. The illumination light L that passes through the exterior member 90 is visually apparent to the user of the keyboard musical instrument 100. In other words, the light emitter 95 is configured to emit light that passes through the base surface F1 of the exterior member 90.

The thin plate portion 92 is light wavelength selective as a result of the wood-based material or the resin material included in the exterior member 90. Here, “light wavelength selective” refers to a property of transmitting only light components that are within a specific wavelength range of an emitted light. For example, the thin plate portion 92 transmits red light components among components of the illumination light L emitted as white light by the light emitter 95, and does not transmit components of the illumination light L other than the red light components. Thus, the red light components are selectively emitted from the base surface F1 of the exterior member 90.

The light emission controller 96 controls emission of light by the light emitter 95. Specifically, the light emission controller 96 controls turning on and turning off the light emitter 95, or controls characteristics of light emitted by the light emitter 95. Such characteristics include, for example, an amount, a color, and a pattern of light emitted by the light emitter 95. The pattern is a pattern corresponding to a duration of light emitted by the light emitter 95, or a pattern corresponding to an interval at which light is emitted by the light emitter 95.

The light emission controller 96 controls emission of light by the light emitter 95 to display various information on the keyboard musical instrument 100. For example, light by the light emitter 95 indicates whether the keyboard musical instrument 100 is turned on or off, or indicates an operation of or an absence of operation of various controls of the keyboard musical instrument 100. It is of note that a configuration can be adopted such that the light emitter 95 includes a plurality of light sources (for example, a seven-segment LED). The light emission controller 96 can cause one or more light sources of the plurality of light sources to emit light to display symbols such as numerical values. For example, the light emission controller 96 may control each of the plurality of light sources to cause the plurality of light sources to display numerical values that denote various parameters related to the keyboard musical instrument 100.

As described above, in the ninth embodiment, the light emitter 95 is disposed inside the recess 91 in the rear surface F2 of the exterior member 90, and the illumination light L emitted by the light emitter 95 passes through the exterior member 90 (thin plate portion 92). Thus, it is possible to realize a variety of designs with varying appearances of the base surface F1. Furthermore, emission of light by the light emitter 95 enables display of a variety of information that relates to the keyboard musical instrument 100.

It is of note that in the above description a configuration is described in which a feature of the eight embodiment is included, in other words, a feature in which the base surface F1 includes the first region R1 and the second region R2; however, a configuration according to the ninth embodiment, in which the illumination light L emitted by the light emitter 95 passes through the exterior member 90, is not required to include a configuration according to the eight embodiment. In other words, the base surface F1 according to the ninth embodiment may be a simple flat surface that is not divided into the first region R1 and the second region R2.

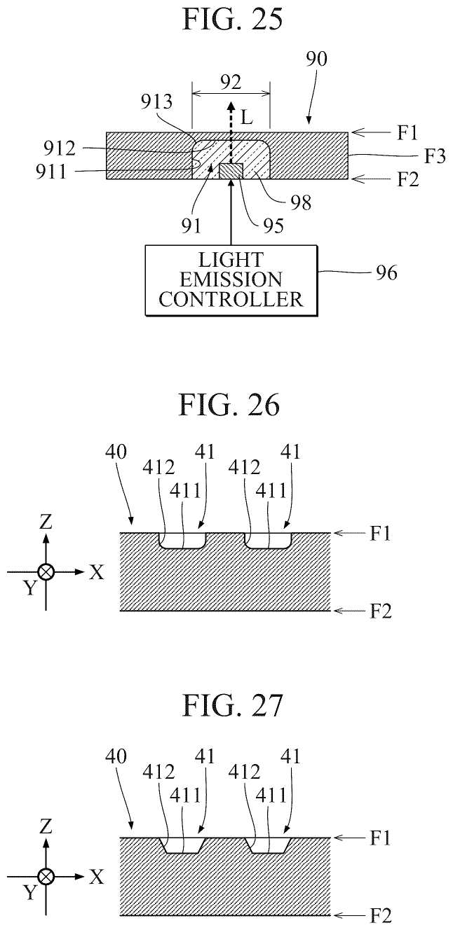

FIG. 25 is a cross-sectional view of an exterior member 90 according to a modification of the ninth embodiment. The keyboard musical instrument 100 shown in FIG. 25 includes a light-transmissive member 98. The transmissive member 98 is disposed within the recess 91. The illumination light L emitted by the light emitter 95 passes through the light-transmissive member 98 and through the exterior member 90 (thin plate portion 92) and is emitted from the base surface F1.

A material of the light-transmissive member 98 can be freely selected. For example, the material of the light-transmissive member 98 may be an acrylic-based resin material or an epoxy-based resin material. For example, a liquid resin material can be provided in the recess 91 and cured to form the light-transmissive member 98. Alternatively, the light-transmissive member 98 can be formed by injection molding and fitted within the recess 91.

As described above, the thin plate portion 92 of the exterior member 90 is thinner than the other portion of the exterior member 90. Thus, there is a possibility that a mechanical strength of the exterior member 90 may be insufficient. According to a configuration shown in FIG. 25 in which the light-transmissive member 98 is disposed within the recess 91, a mechanical strength of the exterior member 90 (particularly, a mechanical strength of the thin plate portion 92) can be readily maintained.

It is of note that FIG. 25 shows the light-transmissive member 98 provided within the recess 91 as described above. However, a configuration of the light-transmissive member 98 is not limited to the above example. For example, a configuration may be adopted such that the light-transmissive member 98 is disposed only in a space close to the bottom surface 912 of the recess 91.

### J: Modifications

The following are examples of modifications of the embodiments described above. Two or more modifications freely selected from the following modifications may be combined as long as no conflict arises from such combination.

(1) The plurality of decorative portions 41 according to the first embodiment are not limited to the example shown in FIG. 3 and FIG. 4. For example, as shown in FIG. 26, the plurality of decorative portions 41 may each be constituted of a recess in which the step surface 411 and the side wall surface 412 are continuous with each other in a curvilinear manner. Alternatively, as shown in FIG. 27, the side wall surface 412 may be inclined relative to the step surface 411 or relative to the base surface F1.

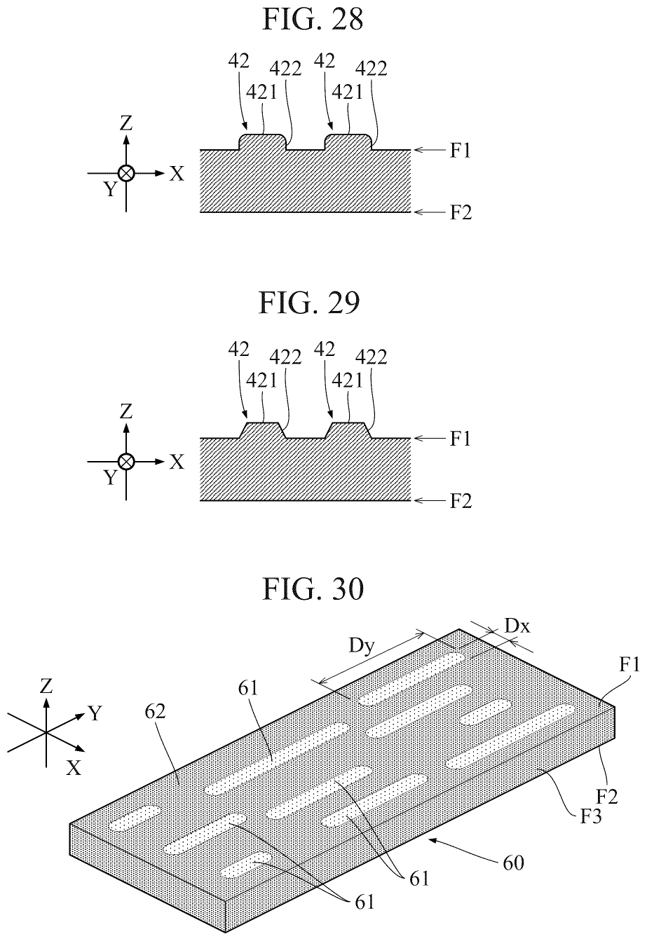

Similarly, the plurality of decorative portions 42 according to the second embodiment are not limited to the example shown in FIG. 5 and FIG. 6. For example, as shown in FIG. 28, the plurality of decorative portions 42 may be constituted as protrusions in which the step surface 421 and the side wall surface 422 are continuous with each other in a curvilinear manner. Alternatively, as shown in FIG. 29, the side wall surface 422 may be inclined relative to the step surface 421 or relative to the base surface F1. The base surface F1 may be provided with the plurality of decorative portions 41 according to the first embodiment and also with the plurality of decorative portions 42 according to the second embodiment.

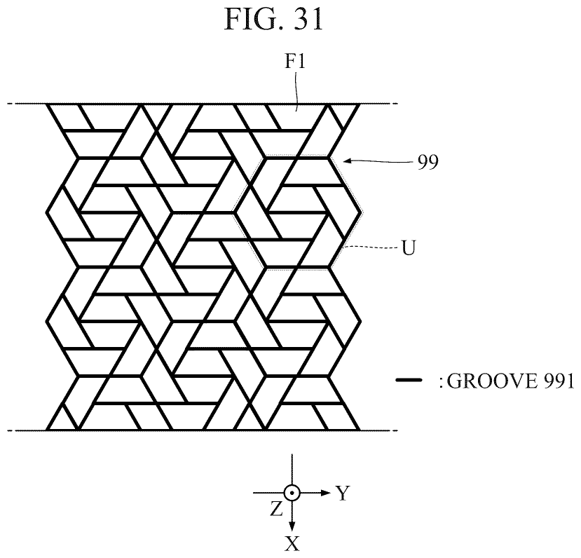

(2) In the fourth embodiment, a configuration is described in which the degree of lightness of the plurality of decorative portions 61 is less than the degree of lightness of the surrounding region 62. However, as shown in FIG. 30, a configuration may be adopted such that the degree of lightness of the surrounding region 62 is less than the degree of lightness of the plurality of decorative portions 61. In the configuration shown in FIG. 30, the color tone of the surrounding region 62 is closer to black than the color tone of the decorative portion 61. As will be understood from the above examples, the exterior member 60 according to the fourth embodiment is an example of a configuration in which the plurality of decorative portions 61 differs in degree of lightness from the surrounding region 62.

(3) An exterior member 99 shown in FIG. 31 may be included in any one of the elements (for example, the housing 20, the right leg 23, the left leg 24, or the music stand 25) of the keyboard musical instrument 100. The exterior member 99 is a plate-shaped elongated member that includes a base surface F1 as a main surface. The base surface F1 is provided with a plurality of grooves 991. The plurality of grooves 991 forms a plurality of unit figurations U. The plurality of unit figurations U are closely arranged on the base surface F1 without any gaps.

A cutter such as a rotary blade is used to form the plurality of grooves 991 in the base surface F1. A surface roughness of an inner wall surface of each of the plurality of grooves 991 is greater than a surface roughness of the base surface F1. In other words, the inner wall surface of each of the plurality of grooves 991 is rougher than the base surface F1. In addition, paint that includes a colorant is applied to the base surface F1. Thus, a degree of lightness of the inner wall surface of each of the plurality of grooves 991 is less than a degree of lightness of the base surface F1. In other words, a color tone of the plurality of grooves 991 is closer to black than a color tone of the base surface F1.

According to the configuration shown in FIG. 31, it is possible to maintain a uniformity of appearance by a configuration in which the plurality of unit figurations U are tightly arranged on the base surface F1, and it is possible to realize a variety of designs with varying appearances by a configuration in which the degree of lightness of the plurality of grooves 991 differs from the degree of lightness of the base surface F1.

(4) The tree species of the wood-based material used for the fiberboard that constitutes any one of the exterior members (40, 50, 60, 70, 80, 90, and 99) according to the first embodiment through the fourth embodiment may be freely selected. For example, a material of the exterior member may include one or more types of wood-based material selected from various tree species such as spruce, Ezo spruce, Agathis, maple, kava, Mansonia altissima, sapele, Australian blackwood, ebony, rosewood, Honduran rosewood, African padauk, granadilla, Pao rosa, walnut, sono keling, ash, ovangkol, olive, or eucalyptus.

(5) A form or a state of the wood-based material used in a production process for the keyboard musical instrument 100 may be freely selected. For example, to produce the keyboard musical instrument 100 (for example, an exterior member), a wood-based material in a freely selected form or state, such as a wood flour, particles, or chips can be used.

(6) In each of the forgoing embodiments, each of the plurality of plate-shaped members 71 is impregnated with the resin material that is cured to provide the bonding material 72. However, in the immersion process P1, the resin material used to impregnate each of the plurality of plate-shaped members 71 may be a material of a type different to the type of the material of the bonding material 72. In other words, the resin material need not have a bonding function. For example, in the immersion process P1, each of the plurality of plate-shaped members 71 may be impregnated with a resin material of a freely selected type such as polyacetal or silicone.

(7) A freely selected element of the keyboard musical instrument 100 may be constituted of the exterior member (40, 50, 60, 70, 80, 90, or 99) according to any one of the forgoing embodiments. For example, the housing 20 or the music stand 25 may be constituted of the exterior member 40 according to the first embodiment, or may be constituted of the exterior member 40 according to the second embodiment, or may be constituted of the exterior member 60 according to the fourth embodiment. The right leg 23, the left leg 24, or the housing 20 may be constituted of the exterior member 50 according to the third embodiment. The right leg 23, the left leg 24, or the music stand 25 may be constituted of the exterior member 70 according to any one of the fifth embodiment through the seventh embodiment. In addition, the keyboard musical instrument 100 may include another element constituted of the exterior member (40, 50, 60, 70, 80, 90, or 99) according to any one of the forgoing embodiments. For example, a freely selected element of the keyboard musical instrument 100 such as the lower member 22 (front plate), a planar member disposed on each side of the keyboard 1, or a keyboard cover, may be constituted of the exterior member according to any one of the forgoing embodiments.

(8) In each of the foregoing embodiments, an electronic musical instrument that includes the audio source 32 is described. However, each of the foregoing embodiments may be applied to an acoustic musical instrument that has a sound emitting mechanism configured to perform a mechanical action to produce sound. The sound emitting mechanism is, for example, a strike mechanism of an acoustic keyboard musical instrument or a resonance mechanism comprised of a sound box and strings of an acoustic stringed musical instrument.

This disclosure may be applied to an instrument playing apparatus that includes neither the audio source 32 nor the sound emitting mechanism. The instrument playing apparatus is, for example, a musical instrument digital interface (MIDI) controller configured to receive user operations. The instrument playing apparatus is an example of the musical instrument (or an example of the keyboard musical instrument) according to this disclosure.

(9) Each of the exterior members (40, 50, 60, 70, 80, 90, and 99) described above may be applied to a musical instrument other than the keyboard musical instrument 100. For example, the exterior member described in each of the foregoing embodiments may be applied to an exterior of a freely selected element of a musical instrument such as a fingerboard or a sound box of a stringed musical instrument, a body of a woodwind musical instrument, a body of an idiophone musical instrument such as a xylophone, or a body of a percussion musical instrument.

In addition, an object to which the exterior member (40, 50, 60, 70, 80, 90, or 99) is applied is not limited to a musical instrument. For example, the exterior member described in each of the foregoing embodiments may be applied to a decorative board of a building.

### K: Supplemental Notes

The following configurations are derivable from the foregoing embodiments. It is of note that two or more supplemental notes freely selected from supplemental notes, which include supplemental notes A1 to A7 related to a supplemental note A, supplemental notes B1 to B12 related to a supplemental note B, supplemental notes C1 to C5 related to a supplemental note C, and supplemental notes D1 to D2 related to a supplemental note D, may be combined as long as no conflict arises from such a combination.

### Supplemental Note A

Techniques have been proposed for material construction of an exterior of a musical instrument such as a keyboard musical instrument. For example, Examined Japanese Patent Publication No. Shou 55-5117 discloses a technique for material construction of a left side and a right side of a keyboard musical instrument, each of which is constructed of a wood core coated with a synthetic resin.

However, the technique disclosed in Examined Japanese Patent Publication No. Shou 55-5117 gives rise to a disadvantage in that an exterior of such a keyboard musical instrument tends to lack a high-grade texture and be monotonous in design. In view of the circumstances described above, an object of one aspect (supplemental note A) of this disclosure is to realize a variety of designs with variations in appearance of an exterior of a musical instrument.

A musical instrument according to one aspect (supplemental note A1) of this disclosure includes an exterior member including a wood-based material, wherein the exterior member includes a base surface constituting an exterior of the first exterior member, and a plurality of decorative portions that are recessed in or protrude from the base surface, wherein a degree of lightness of a side wall surface of each of the plurality of decorative portions is less than a degree of lightness of the base surface, and wherein in a plan view of the base surface, each of the plurality of decorative portions is elongated along a first direction of the base surface. The exterior member is an example of a first exterior member.

In this aspect, it is possible to maintain a uniformity of appearance by a configuration in which longitudinal directions of the plurality of decorative portions are uniform in direction, and it is possible to realize a variety of designs with variations in appearance by a configuration in which the degree of lightness of the side wall surface of each of the plurality of decorative portions differs from the degree of lightness of the base surface.

The “base surface” is a surface (for example, a plane surface or a curved surface) that constitutes the exterior of the musical instrument. In other words, the “base surface” is a surface that constitutes a visual appearance of the musical instrument. When each of the plurality of decorative portions is a recess, the “side wall surface” is an inner surface between a bottom surface of the recess and the base surface. Alternatively, when each of the plurality of decorative portions is a protrusion, the “side wall surface” is an outer surface between a top surface of the protrusion and the base surface.

A difference between the degree of lightness of the side wall surface and the degree of lightness of the base surface can be caused by a difference in surface roughness between the side wall surface and the base surface. Alternatively, the difference between the degree of lightness of the side wall surface and the degree of lightness of the base surface may be caused by a difference in color tone between a paint applied to the side wall surface and a paint applied to the base surface. In a configuration in which the side wall surface is rougher than the base surface, when a type of paint applied to the side wall surface is the same as a type of paint applied to the base surface, it is possible to realize an appearance in which the degree of lightness of the side wall surface is less than the degree of lightness of the base surface.

In a specific example (supplemental note A2) of the supplemental note A1, a difference in level between the base surface and each of the plurality of decorative portions is greater than or equal to 1% of a thickness of the exterior member. According to this aspect, the side wall surface of each of the plurality of decorative portions is sufficiently secure. Thus, it is possible to realize a variety of designs in which a difference in degree of lightness between the side wall surface of each of the plurality of decorative portions and the base surface is emphasized.

When each of the plurality of decorative portions is a recess, the “difference in level between the base surface and each of the plurality of decorative portions” refers to a depth of the recess (a difference in height between a bottom surface of the recess and the base surface). Alternatively, when each of the plurality of decorative portions is a protrusion, the “difference in level between the base surface and each of the plurality of decorative portions” refers to a height of the protrusion (a difference in height between a top surface of the protrusion and the base surface).

In a specific example (supplemental note A3) of the supplemental note A1 or A2, each of the plurality of decorative portions has a first size in the first direction and a second size in a second direction perpendicular to the first direction, and a ratio of the first size in the first direction to the second size in the second direction is greater than or equal to two. According to this aspect, the base surface is provided with the plurality of decorative portions, each of which has the aspect ratio Dy/Dx of 2 or more, such that a longitudinal direction of each of the plurality of decorative portions is along the first direction. Thus, it is possible to emphasize uniformity of appearance of the exterior member.

A musical instrument according to another aspect (supplemental note A4) of this disclosure includes an exterior member, wherein the exterior member includes a plate-shaped member including a base surface that has an opening, and a design member fitted to the opening of the plate-shaped member, wherein the design member includes a design surface having a normal line along a normal line of the base surface, wherein a degree of lightness of the design surface is less than a degree of lightness of the base surface, and wherein the design surface includes a plurality of protrusions arranged between a pair of opposite sides of the design member. It is of note that the exterior member may include a wood-based material.

According to this aspect, it is possible to realize a variety of designs in which the design surface, which has the degree of lightness that is less than the degree of lightness of the base surface, is provided with the plurality of protrusions. In addition, the design member is fitted in the opening of the base surface. Thus, it is possible to produce a shape in which an inner wall surface of the opening of the base surface and an outer surface of the design member are in contact with each other at a desired angle. It is of note that the opening of the base surface may be a through hole that penetrates through the exterior member, or alternatively, the opening of the base surface may be a bottomed hole that does not penetrate through the exterior member.

A musical instrument according to yet another aspect (supplemental note A5) of this disclosure includes an exterior member comprising an isotropic fiberboard, wherein the isotropic fiberboard includes a base surface constituting an exterior of the musical instrument, wherein the base surface includes a plurality of decorative portions, and a surrounding region other than the plurality of decorative portions, wherein a degree of lightness of the plurality of decorative portions differs from a degree of lightness of the surrounding region, and wherein in a plan view of the base surface, each of the plurality of decorative portions is elongated along a first direction of the base surface. It is of note that the exterior member may include a wood-based material.

In this aspect, it is possible to maintain a uniformity of appearance by a configuration in which longitudinal directions of the plurality of decorative portions are uniform, and it is possible to realize a variety of designs with variations in appearance by a configuration in which the degree of lightness of the plurality of decorative portions of the base surface differs from the degree of lightness of the surrounding region of the base surface. In addition, although the exterior member is in a form of an isotropic fiberboard, it is possible to realize a visual effect such that the exterior member has an appearance of an anisotropic material.

The term “isotropic” denotes that physical properties such as strength are substantially independent of a direction. A plate of “fiberboard” is a plate-shaped member formed by subjecting fibers of a wood-based material to heat and pressure, and molding together the fibers of the wood-based material into a desired shape. For example, the exterior member is constituted of fiberboard such as medium density fiberboard (MDF), hardboard, or insulation board.

A degree of lightness of a part of a decorative portion, which is any one of the plurality of decorative portions, need not be equal to that of another part of the decorative portion. For example, a part of the decorative portion may differ in degree of lightness from another part of the decorative portion. The “degree of lightness” of each of the plurality of decorative portions refers to a degree of average lightness of a portion of the base surface that corresponds to the plurality of decorative portions.

In a specific example (supplemental note A6) of any of the supplemental notes A1 to A5, a degree of average lightness of a side surface of the exterior member is less than a degree of average lightness of a region of the base surface other than the plurality of decorative portions. According to this aspect, compared to a configuration in which the degree of average lightness of the side surface of the exterior member is substantially the same as the degree of average lightness of the region that is the portion of the base surface other than the plurality of decorative portions, it is possible to realize a variety of designs with variations in appearance.

In a specific example (supplemental note A7) of any of the supplemental notes A1 to A6, the first exterior member is an elongated member that has a longitudinal direction along the first direction. According to this aspect, each of the plurality of decorative portions is disposed along the longitudinal direction of the exterior member. Thus, it is possible to realize visual effects such that the plurality of decorative portions has an appearance of wood grain along a longitudinal direction of a wooden plate. The visual effects described above provide an impression that a strength of the exterior member in its longitudinal direction is greater than a strength of the exterior member in its lateral direction.

### Supplement Note B

Techniques have been proposed for material construction of an exterior of a musical instrument such as a keyboard musical instrument. For example, Examined Japanese Patent Publication No. Shou 55-5117 discloses a technique for material construction of a left side and a right side of a keyboard musical instrument, each of which is constructed of a wood core coated with a synthetic resin.

However, the technique disclosed in Examined Japanese Patent Publication No. Shou 55-5117 gives rise to a disadvantage in that an exterior of such a keyboard musical instrument tends to lack a high-grade texture and to be monotonous in design. In view of the circumstances described above, an object of one aspect (supplemental note B) of this disclosure is to realize a variety of designs with variations in appearance of an exterior of a musical instrument.

A musical instrument according to one aspect (supplemental note B1) of this disclosure includes an exterior member, wherein the exterior member includes a plurality of plate-shaped members that are accumulated in a direction along a surface of the exterior member and are accumulated in a direction of a thickness of the exterior member, and a bonding material bonding together the plurality of plate-shaped members, wherein at least one plate-shaped member of the plurality of plate-shaped members is bonded by the bonding material to another plate-shaped member of the plurality of plate-shaped members, the at least one plate-shaped member being curved. The exterior member is an example of a second exterior member.

According to this aspect, the at least one plate-shaped member of the plurality of plate-shaped members included in the exterior member is bonded by the bonding material to another plate-shaped member of the plurality of plate-shaped members with the at least one plate-shaped member being curved. Thus, compared to a configuration in which the plurality of plate-shaped members are accumulated and joined together, with each of the plurality of plate-shaped members maintaining a shape of a flat plate (a configuration in which a cut surface of the exterior member is in simple layers), it is possible to realize a variety of designs in which at least one straight line and at least one curved line are non-uniformly mixed in a cut surface of the exterior member.

In a specific example (supplemental note B2) of the supplemental note B1, an average thickness of each of the plurality of plate-shaped members is less than 0.5 mm. The plate-shaped member having an average thickness less than 0.5 mm can be deformed. Thus, it is possible to realize the exterior member that includes an exterior surface representative of multiple curved lines corresponding to plate-shaped members that are curved.

In a specific example (supplemental note B3) of the supplemental note B1 or B2, an exterior surface of the exterior member is provided with a cut surface of the at least one plate-shaped member. According to this aspect, the exterior surface of the exterior member is provided with a cut surface of the at least one plate-shaped member that is fixed in a curved state. Thus, it is possible to realize a variety of designs in which at least one straight line and at least one curved line are non-uniformly mixed in the exterior surface of the exterior member.

In a specific example (supplemental note B4) of any of the supplemental notes B1 to B3, the bonding material is provided in a space between the at least one plate-shaped member that is curved and another plate-shaped member of the plurality of plate-shaped members. According to this aspect, the bonding material is provided in the space between the at least one plate-shaped member that is curved and another plate-shaped member of the plurality of plate-shaped members. Thus, the cut surface of the exterior member is provided with a cut surface of the bonding material. Consequently, it is possible to realize the exterior member with a cut surface having a complicated pattern that includes the cross section of the bonding material, a straight line constituted of at least one plate-shaped member, and a curved line constituted of at least one plate-shaped member.

In a specific example (supplemental note B5) of the supplemental note B4, the musical instrument further comprises an air bubble in the bonding material provided in the space. According to this aspect, the air bubble is present in the bonding material provided in the space. Thus, it is possible to realize the exterior member with a cut surface having a complicated pattern, which includes the air bubble present in the space, the straight line constituted of at least one plate-shaped member, the curved line constituted of at least one plate-shaped member, and the cross section of the bonding material.

In a specific example (supplemental note B6) of any of the supplemental notes B1 to B5, the exterior member further includes at least one decorative member, and a ratio A2/A1 is less than or equal to 0.5, where A1 is an area of a main surface of the exterior member, and A2 is a projected area of the decorative member on the main surface. According to this aspect, the exterior member includes the decorative member, the plurality of plate-shaped members, and the bonding material. Thus, it is possible to realize a distinctive design in which an artificial decorative member is included in the plate-shaped members that are randomly accumulated. In addition, the ratio of the projected area of the decorative member to the area of the main surface of the exterior member is less than or equal to 50%. Thus, compared to a configuration in which a large number of decorative members are provided, it is possible to realize a unique design in which the decorative member is emphasized.

The “decorative member” is a member that is used for decoration of the exterior member. For example, the decorative member may be constituted of an artificial object of a predetermined shape and made, for example, of a plastic. Alternatively, the decorative member may be constituted of a natural object such as a leaf or a flower of a plant.

In a specific example (supplemental note B7) of any of the supplemental notes B1 to B6, the bonding material is light permeable. According to this aspect, since the bonding material is light permeable, it is possible to realize a design such that the accumulation of the plurality of plate-shaped members can be easily recognized.

In a specific example (supplemental note B8) of any of the supplemental notes B1 to B7, the bonding material includes a colorant. According to this aspect, it is possible to provide the exterior member with a distinctive appearance in which visibility of the bonding material is ensured. The “colorant” is used to impart a specific color tone to the bonding material, and is a pigment or a dye, for example.

In a specific example (supplemental note B9) of any of the supplemental notes B1 to B8, the plurality of plate-shaped members is impregnated with a resin. According to this aspect, a characteristic appearance of each of the plurality of plate-shaped members can be modified by the resin. For example, according to a configuration in which a resin used as the bonding material permeates in the plurality of plate-shaped members, compared to a configuration in which the bonding material is in contact with only an outer surface of each of the plurality of plate-shaped members, it is possible to firmly join together the plurality of plate-shaped members. It is of note that the resin need not have a function of bonding together the plurality of plate-shaped members. Here “permeation” refers to permeation of a liquid resin material in minute holes in the outer surface of each of the plate-shaped members. Thus, “permeation” here differs to providing the resin into the space between a curved plate-shaped member and a plate-shaped member.

In a specific example (supplemental note B10 of any of the supplemental notes B1 to B9, each of the plurality of plate-shaped members comprises a wood-based material. According to this aspect, it is possible to realize the exterior member that has a texture particular to the wood-based material.

In a specific example (supplemental note B11) of the supplemental note B10, the plurality of plate-shaped members includes multiple wood-based materials of different tree species. According to this aspect, it is possible to realize a variety of designs having a texture unique to each of the tree species.

In a specific example (supplemental note B12) of any of the supplemental notes B1 to B11, the musical instrument further includes a light-permeable covering layer that covers at least a portion of a surface of the exterior member. According to this aspect, the covering layer covers the at least the portion of the surface of the exterior member. Thus, it is possible to even out irregularities of the exterior member caused by outer shapes of two or more plate-shaped members.

### Supplemental Note C

A musical instrument according to one aspect (supplemental note C1) of this disclosure includes an exterior member comprising an isotropic fiberboard, wherein the isotropic fiberboard includes an exterior surface comprising a first region and a second region, wherein a surface roughness of the first region differs from a surface roughness of the second region, and wherein a degree of reflection of the first region differs from a degree of reflection of the second region. According to this aspect, the first region differs in surface roughness and in degree of reflection from the second region. Thus, it is possible to realize a variety of designs with variations in appearance.

The term “isotropic” means that physical properties such as strength are substantially independent of a direction. The “fiberboard” is a plate-shaped member formed by subjecting to heat and pressure fibers of a wood-based material, and molding the fibers together into a desired shape. The “exterior surface” is a surface (for example, a plane surface or a curved surface) that constitutes an exterior of the musical instrument. Specifically, the “exterior surface” is a surface constituting an appearance of the musical instrument.

A “surface roughness” refers to an index of roughness of a surface of a member (in other words, a magnitude of unevenness). A surface roughness is, for example, an arithmetic mean roughness Ra, a maximum height Ry, or a ten-point height of irregularities Rz. A surface roughness of a part of the first region need not be equal to that of another part of the first region. For example, a part of the first region may differ in surface roughness from another part of the first region. The “surface roughness of the first region” denotes an average surface roughness of the first region. Similarly, a surface roughness of a part of the second region need not be equal to that of another part of the second region. For example, a part of the second region may differ in surface roughness from another part of the second region. The “surface roughness of the second region” refers to an average surface roughness of the second region.

A “degree of reflection” refers to an index of a degree of lightness of a surface of a member. For example, an example of “a degree of reflection” is a ratio of an amount of light reflected by a surface to an amount of light received by the surface. A degree of reflection of a part of the first region need not be equal to that of another part of the first region. For example, a part of the first region may differ in degree of reflection from another part of the first region. The “degree of reflection of the first region” refers to an average degree of reflection of the first region. Similarly, the degree of reflection of a part of the second region need not be equal to that of another part of the second region. For example, a part of the second region may differ in degree of reflection from another part of the second region. The “degree of reflection of the second region” refers to an average degree of reflection of the second region.

The difference in degree of reflection between the first region and the second region may be caused by the difference in surface roughness between the first region and the second region. Alternatively, the difference in degree of reflection between the first region and the second region may be caused by a difference in color tone between a paint applied to the first region and a paint applied to the second region surface. A color tone is affected by any one of three properties including a degree of lightness (value), a degree of saturation (chroma), and a hue; or alternatively, “a color tone” is affected by a combination of two or more properties among the three properties. In a configuration in which the first region is rougher than the second region, when a type of paint applied to the first region is the same as a type of paint applied to the second region, it is possible to realize a difference between an amount of paint that remains on the first region and that remains on the second region. Thus, it is possible to realize an appearance in which the degree of reflection of the first region is less than the degree of reflection of the second region. Alternatively, in a configuration in which the first region differs in surface roughness from the second region by directing a laser beam to either the first region or the second region, the first region may differ in degree of lightness from the second region due to burning of a portion of the exterior surface by the laser beam.

In a specific example (supplemental note C2) of the supplemental note C1, the surface roughness of the first region is greater than the surface roughness of the second region, and the degree of reflection of the first region is less than the degree of reflection of the second region. According to this aspect, the first region is rougher than the second region, and the degree of reflection of the first region is less than the degree of reflection of the second region. Thus, by a simple process of roughening the first region, it is possible to reduce the degree of reflection of the first region.

In a specific example (supplemental note C3) of the supplemental note C2, an area of the first region is less than an area of the second region. According to this aspect, the area of the first region is less than the area of the second region. Thus, for example, compared to a configuration in which the area of the first region is equal to the area of the second region, it is possible to realize a variety of designs variations in appearance.

In a specific example (supplemental note C4) of any of the supplemental notes C1 to C3, the exterior surface comprises a painted surface. According to this aspect, since the first region is rougher than the second region, the first region is likely to retain more paint than the second region. A difference in amount of retained paint between the first region and the second region causes a difference in a degree of reflection between the first region and the second region.

One aspect of this disclosure relates to a method for producing the musical instrument according to the supplemental note C (C1 to C4) described above. A production method according to one aspect (supplemental note C5) is a method for producing a musical instrument, the method including roughening, by irradiation with a laser beam, a first region of an exterior surface of an isotropic fiberboard, and applying a paint to the exterior surface, wherein the isotropic fiberboard having the roughened and painted exterior surface is an exterior member of the musical instrument. According to this aspect, the laser beam is directed to the exterior surface, and the paint is applied to the exterior surface. Thus, it is possible to easily cause a difference in surface roughness and in a degree of reflection between the first region of the exterior surface and the second region of the exterior surface.

It is of note that the order of a process of roughening the exterior surface by directing the laser beam to the first region and a process of applying the paint to the exterior surface may be freely selected. In other words, the paint may be applied to the exterior surface roughened by the laser beam, or alternatively, the laser beam may be directed to the exterior surface to which the paint is applied.

### Supplemental Note D

A musical instrument according to one aspect (supplemental note D1) of this disclosure includes an exterior member comprising an isotropic fiberboard, and a light emitter, wherein the isotropic fiberboard includes a rear surface that faces away from the exterior surface, wherein the rear surface includes a recess, wherein the light emitter is disposed within the recess, and wherein the light emitter is configured to emit light that passes through the exterior surface of the isotropic fiberboard. According to this aspect, the light emitter is disposed within the recess in the rear surface of the exterior member, and the light emitted by the light emitter passes through the exterior member. Thus, it is possible to realize a variety of designs with variations in appearance of the exterior surface, and light emitted by the light emitter can display various information related to the keyboard musical instrument.

The “light emitter” is a freely selected element configured to emit light. An example of the light emitter is a light-emitting element such as a light-emitting diode. The “light emitter” may be a single light source, or alternatively, the light emitter may be a combination of a plurality of light sources (for example, a seven-segment LED).

For example, the light emitter displays various information related to the musical instrument. For example, information can be displayed by turning on and off the light emitter or by emission characteristics of the light emitter (for example, an amount of emitted light, or an emitted light color). The information displayed by the light emitter is freely selected. For example, the light emitter may display information, such as information about turning on and off the musical instrument such as an electronic musical instrument, information about a presence or absence of a user operation, information about numerical values of various parameters related to the musical instrument, or information about an effective state and a non-effective state (turning on and off) of each of various settings related to the musical instrument.

In a specific example (supplemental note D2) of the supplemental note D1, the musical instrument further includes a light-transmissive member disposed within the recess, wherein the light emitted from the light emitter passes through the light-transmissive member and the exterior surface of the isotropic fiberboard. The portion of the exterior member provided with the recess is thinner than the other portion of the exterior member. Thus, there is a possibility that mechanical strength of the exterior member may be insufficient. According to this aspect in which the light-transmissive member is disposed within the recess, it is possible to maintain the mechanical strength of the exterior member.

### DESCRIPTION OF REFERENCE SIGNS

100 . . . keyboard musical instrument, 1 . . . keyboard, 2 . . . support, 10 . . . key, 20 . . . housing, 21 . . . upper member, 22 . . . lower member, 23 . . . right leg, 24 . . . left leg, 25 . . . music stand, 31 . . . detection device, 32 . . . audio source, 33 . . . sound emitting device, 40 . . . exterior member, 41 . . . decorative portion, 42 . . . decorative portion, 50 . . . exterior member, 51 . . . plate-shaped member, 52 . . . design member, 60 . . . exterior member, 61 . . . decorative portion, 62 . . . surrounding region, 70 . . . exterior member, 71 . . . plate-shaped member, 72 . . . bonding material, 73 . . . storage space, 74 . . . bubble, 75 . . . decorative member, 76 . . . coating layer, 78 . . . molded body, 80 . . . exterior member, 81 . . . first surface layer, 82 . . . second surface layer, 83 . . . intermediate layer, R1 . . . first region, R2 . . . second region, 85 . . . processing machine, 851 . . . laser, 852 . . . controller, 90 . . . exterior member, 91 . . . recess, 911 . . . inner wall surface, 912 . . . bottom surface, 92 . . . thin plate portion, 95 . . . light emitter, 96 . . . light emission controller, 99 . . . exterior member, 991 . . . groove, 411 . . . step surface, 412 . . . side wall surface, 421 . . . step surface, 422 . . . side wall surface, 511 . . . opening, 512 . . . inner wall surface, 521 . . . outer wall surface, 522 . . . design surface, 523 . . . protrusion.

What is claimed is:

1. A musical instrument comprising:
an exterior member comprising an isotropic fiberboard,
wherein the isotropic fiberboard includes an exterior surface comprising a first region and a second region,
wherein a surface roughness of the first region differs from a surface roughness of the second region, and
wherein a degree of reflection of the first region differs from a degree of reflection of the second region.

2. The musical instrument according to claim 1,
wherein the surface roughness of the first region is greater than the surface roughness of the second region, and
wherein the degree of reflection of the first region is less than the degree of reflection of the second region.

3. The musical instrument according to claim 2, wherein an area of the first region is less than an area of the second region.

4. The musical instrument according to claim 1, wherein the exterior surface comprises a painted surface.

5. The musical instrument according to claim 1, further comprising:
a light emitter,
wherein the isotropic fiberboard includes a rear surface that faces away from the exterior surface,
wherein the rear surface includes a recess,
wherein the light emitter is disposed within the recess, and
wherein the light emitter is configured to emit light that passes through the exterior surface of the isotropic fiberboard.

6. The musical instrument according to claim 5, further comprising:
a light-transmissive member disposed within the recess,
wherein the light emitted from the light emitter passes through the light-transmissive member and the exterior surface of the isotropic fiberboard.

7. A musical instrument comprising:
an exterior member comprising an isotropic fiberboard; and
a light emitter,
wherein the isotropic fiberboard includes an exterior surface and a rear surface that faces away from the exterior surface,
wherein the rear surface includes a recess,
wherein the light emitter is disposed within the recess, and
wherein the light emitter is configured to emit light that passes through the exterior surface of the isotropic fiberboard.

8. A method for producing a musical instrument, the method comprising:
roughening, by irradiation with a laser beam, a first region of an exterior surface of an isotropic fiberboard; and
applying a paint to the exterior surface,
wherein the isotropic fiberboard having the roughened and painted exterior surface is an exterior member of the musical instrument.

9. A musical instrument comprising:
a first exterior member including a wood-based material,
wherein the first exterior member includes:
a base surface constituting an exterior of the first exterior member; and
a plurality of decorative portions that are recessed in or protrude from the base surface,
wherein a degree of lightness of a side wall surface of each of the plurality of decorative portions is less than a degree of lightness of the base surface, and
wherein in a plan view of the base surface, each of the plurality of decorative portions is elongated along a first direction of the base surface.

10. The musical instrument according to claim 9, wherein a difference in level between the base surface and each of the plurality of decorative portions is greater than or equal to 1% of a thickness of the first exterior member.

11. The musical instrument according to claim 9, wherein each of the plurality of decorative portions has a first size in the first direction and a second size in a second direction perpendicular to the first direction, and a ratio of the first size in the first direction to the second size in the second direction is greater than or equal to two.

12. A musical instrument comprising:
a first exterior member,
wherein the first exterior member includes:
a plate-shaped member including a base surface that has an opening; and
a design member fitted to the opening of the plate-shaped member,
wherein the design member includes a design surface having a normal line along a normal line of the base surface,
wherein a degree of lightness of the design surface is less than a degree of lightness of the base surface, and
wherein the design surface includes a plurality of protrusions arranged between a pair of opposite sides of the design member.

13. A musical instrument comprising:
a first exterior member comprising an isotropic fiberboard,
wherein the isotropic fiberboard includes a base surface constituting an exterior of the musical instrument,
wherein the base surface includes:
a plurality of decorative portions; and
a surrounding region other than the plurality of decorative portions,
wherein a degree of lightness of the plurality of decorative portions differs from a degree of lightness of the surrounding region, and
wherein in a plan view of the base surface, each of the plurality of decorative portions is elongated along a first direction of the base surface.

14. The musical instrument according to claim 9, wherein a degree of average lightness of a side surface of the first exterior member is less than a degree of average lightness of a region of the base surface other than the plurality of decorative portions.

15. The musical instrument according to claim 9, wherein the first exterior member is an elongated member that has a longitudinal direction along the first direction.

16. The musical instrument according to claim 9, further comprising:
a second exterior member,
wherein the second exterior member includes:
a plurality of plate-shaped members that are accumulated in a direction along a surface of the second exterior member and are accumulated in a direction of a thickness of the second exterior member; and
a bonding material bonding together the plurality of plate-shaped members,
wherein at least one plate-shaped member of the plurality of plate-shaped members is bonded by the bonding material to another plate-shaped member of the plurality of plate-shaped members, the at least one plate-shaped member being curved.

17. The musical instrument according to claim 16, wherein an average thickness of each of the plurality of plate-shaped members is less than 0.5 mm.

18. The musical instrument according to claim 16, wherein an exterior surface of the second exterior member is provided with a cut surface of the at least one plate-shaped member.

19. The musical instrument according to claim 16, wherein the bonding material is provided in a space between the at least one plate-shaped member that is curved and another plate-shaped member of the plurality of plate-shaped members.

20. The musical instrument according to claim 19, further comprising an air bubble in the bonding material provided in the space.

21. The musical instrument according to claim 16,
wherein the second exterior member further includes at least one decorative member, and
wherein a ratio A2/A1 is less than or equal to 0.5, where A1 is an area of a main surface of the second exterior member, and A2 is a projected area of the decorative member on the main surface.
